(19) United States
(12) Patent Application Publication
(10) Pub. No.: US 2010/0169778 A1
(43) Pub. Date: Jul. 1, 2010

(54) System and method for browsing, selecting and/or controlling rendering of media with a mobile device

(76) Inventors: L. Starlight Mundy, San Diego, CA (US); Rick Schwartz, Carlsbad, CA (US); Ken Clapp, San Diego, CA (US); Ralph Neff, San Diego, CA (US)

Correspondence Address: PATENTS+TMS, P.C., 2849 W. ARMITAGE AVE., CHICAGO, IL, 60647, US

(21) Appl. No.: 12/592,838

(22) Filed: Dec. 3, 2009

Related U.S. Application Data
(60) Provisional application No. 61/200,801, filed on Dec. 4, 2008.

(51) Int. Cl. G06F 3/00; G09G 5/00

(52) U.S. Cl. 715/716; 345/619

(57) ABSTRACT

A system and a method enable browsing, selecting and/or controlling rendering of media with a mobile device. Content from multiple content sources is aggregated, and a default content source and/or a default rendering device used for subsequent media selection are established. Individual media playback shortcuts are associated with specific default rendering devices. A user may navigate within a collection of content without a need to repeat full content browsing and selection. A user interface of a multimedia player and/or playback controller on the mobile device displays active metadata tags. By selecting an active metadata tag, the user may access a list of associated metadata tag values. By selecting a tag value, the user may select a set of content associated with the tag value for rendering.

This application claims the benefit of U.S. Provisional Application Ser. No. 61/200,801 filed Dec. 4, 2008.

### BACKGROUND OF THE INVENTION

The present invention generally relates to a system and a method for browsing, selecting and/or controlling rendering of media with a mobile device. More specifically, the present invention relates to a system and a method that aggregate content from multiple content sources, establish a default content source and establish a default rendering device used for subsequent media selection. The system and the method enable navigation within a collection of content without a need to repeat full content browsing and selection.

It is well known for a user to browse, select, render and/or control rendering of multimedia content using a mobile device. A mobile device may be used to render and/or to control rendering of multimedia content in various typical usage scenarios. For example, in a first usage scenario, the mobile device may function as a self-contained portable media player that enables a user of the mobile device to browse and/or to select multimedia content stored on the mobile device for rendering on the mobile device. The multimedia content may be stored in an internal memory of the mobile device and/or on a removable storage module attached to the mobile device. The mobile device typically transfers the multimedia content into the internal memory and/or into the removable storage module for rendering at a later time. Examples of mobile devices that employ the first usage scenario are MP3 players, portable video players, mobile phones with audio player capability and/or video player capability, portable gaming consoles with audio capability and/or video player capability and/or the like.

In a second usage scenario, the mobile device may function as a networked portable media player that enables the user of the mobile device to browse and/or to select multimedia content accessible via a network. The mobile device may retrieve and/or may render the multimedia content on the mobile device. An example of a mobile device that employs the second usage scenario is a mobile phone with audio capability and/or video player capability that may access the multimedia content via a mobile carrier network. The mobile carrier network may download and/or may stream the multimedia content to the mobile device for rendering on the mobile device. Another example of a mobile device that employs the second usage scenario is a portable media player connected to a home network that may access multimedia content stored on media servers connected to the home network. The media servers may download and/or may stream the multimedia content to the mobile device for rendering on the mobile device. The portable media player may exercise standard UPnP AV Control Point and Renderer functionality as known in the art.

In a third usage scenario, the mobile device may function as a portable media server and playback controller that enables the user of the mobile device to browse and/or to select multimedia content stored on the mobile device. The mobile device transmits the selected multimedia content to an external rendering device for rendering and controls rendering of the selected multimedia content by the external rendering device. An example of a mobile device that employs the third usage scenario is a mobile phone equipped with a camera. The mobile phone may enable the user to browse and/or to select digital photos and/or digital videos captured via the camera and/or stored on the mobile phone. The mobile phone initiates and/or controls rendering of selected digital photos and/or selected digital videos by an external rendering device. The external rendering device may be, for example, a networked digital television or a networked digital photo frame, either of which may have standard UPnP AV rendering capability. Another example of a mobile device that employs the third usage scenario is a portable music player that enables the user to browse and/or to select songs stored on the music player. The portable music player may initiate and/or may control rendering of selected songs on an external rendering device. The external rendering device may be, for example, a networked home stereo which may have standard UPnP AV rendering capability.

In a fourth usage scenario, the mobile device may function as a portable media control point that enables the user of the mobile device to browse and/or to select multimedia content accessible via a network and to initiate and/or to control rendering of selected multimedia content by an external rendering device. An example of a mobile device that employs the fourth usage scenario is a networked remote control device with standard UPnP AV Control Point functionality. The network remote control device may enable the user to determine UPnP AV Media Servers connected to a home network and/or to browse and/or to select multimedia content available from the UPnP AV Media Servers. The network remote control device may enable the user to determine and/or to select an available rendering device connected to the home network and/or to initiate and/or to control rendering of selected multimedia content on a selected rendering device. Another example of a mobile device that employs the fourth usage scenario is a mobile phone with standard UPnP AV Control Point functionality that provides similar functionality to the networked remote control device described previously.

A mobile device may have capability to support two or more of the typical usage scenarios. The typical usage scenarios may differ from each other based on a location of the multimedia content, such as, for example, in storage of the mobile device, a location accessible to the mobile device via a network and/or a combination of multimedia content locations. In addition, the typical usage scenarios may differ from each other based on a location of the rendering device, such as, for example, the mobile device itself, an external rendering device controlled by the mobile device and/or a combination of rendering device locations.

However, the tasks for the user of the mobile device are similar for all of the typical usage scenarios. A first task for the user is to determine available content sources and to select one or more of the available content sources for browsing. The content sources may be a media server connected to a home network, a content service available via a mobile carrier network, a collection of content files stored on the mobile device, a collection of content files stored on a removable storage element attached to the mobile device and/or a similar source of multimedia content. The first task may not be necessary in a situation having only one available content source. However, a situation with multiple content sources is increasingly common. For example, a typical mobile phone may have multimedia content stored in internal memory, may have multimedia content available from an attached memory card and may have access to a content service via the mobile carrier network. A mobile phone may have access to all of these content sources and may additionally connect to a home network to access multimedia content from media servers connected to the home network.

A second task for the user is to browse multimedia content available on one or more selected content sources to select multimedia content for rendering. Typically, the user may browse and/or may select multimedia content based on metadata associated with the multimedia content. The content source may provide the metadata which may have fields, such as Title, Artist, Album, Genre, Rating, Duration and/or the like. Browsing the multimedia content of a content source may require navigation of a content hierarchy and/or a directory structure. Browsing the multimedia content of a content source may also utilize enhanced methods, such as, for example, searching based on search terms provided by the user and/or filtering and/or limiting browse results based on a specific metadata condition. The second task is typically burdensome for the user. Detailed user interaction may be required for the user to determine the available content, to learn about the content from metadata associated with the available content and/or to select desired content objects for rendering. The user may save the browse results as a playlist. The playlist may be stored on the mobile device and/or may be stored on a device accessible to the mobile device via a network, such as, for example, a media server connected to the network.

A third task for the user is to determine available rendering devices and to select a rendering device to render selected multimedia content. The third task may not be necessary in a situation having only one available rendering device, such as, for example, if the mobile device only supports rendering on the mobile device itself and does not support control of an external rendering device.

Existing products may allow the user to browse, to select, to initiate rendering of, and/or to control rendering of multimedia content using a mobile device. However, performing the previously described tasks may be difficult and/or may be time-consuming due to limited display size and/or limited user input capabilities of a typical mobile device. The second task of browsing and selecting content may be particularly difficult using a mobile device. Due to the limited display size, the typical mobile device may provide a display that may be small relative to a size of a list of the available multimedia content. Thus, the user may be required to navigate through many screens representing locations in the content hierarchy and/or the content directory structure. For each screen, the user may be required to scroll through more multimedia content than can be legibly displayed on a mobile device screen. A large amount of user input may be required to determine and/or to select the multimedia content. Further, the display may not be large enough and/or may not have a sufficient resolution to enable the user to browse a content source and simultaneously maintain a view of multimedia content previously selected. The mobile device may provide a search function to simplify the browsing. However, the typical mobile device does not have a full alphanumeric keyboard. Therefore, browsing may be difficult and/or time-consuming because the user must enter textual search terms without a full alphanumeric keyboard. The user may often repeat entry of the textual search terms several times to narrow the browse results and/or to select a combination of multimedia content from different searches.

Typical mobile multimedia player/controller products require the user to initially perform the second task of browsing and selecting multimedia content to initiate rendering of selected multimedia content using a mobile device user interface. After rendering is initiated, the user must repeat the second task of browsing and selecting multimedia content to select new multimedia content. For example, the user may desire adding multimedia content to an existing list of selected multimedia content or the user may desire selecting an entirely new set of multimedia content to replace the existing list of selected multimedia content. In either case, the user may be required to repeat the second task of browsing and selecting multimedia content to determine and/or to select new multimedia content. A mobile device may also require the user to complete the first. task of determining available content sources and selecting one or more of the available content sources for browsing and/or the third task of determining available rendering devices and selecting a rendering device to render selected multimedia content.

A need, therefore, exists for a system and a method for browsing, selecting and/or controlling rendering of media with a mobile device. Further, a need exists for a system and a method that reduce the need for the user to select a content source and/or a rendering device. Still further, a need exists for a system and a method that establish a default content source used for subsequent media selection tasks. Still further, a need exists for a system and a method that aggregate content from multiple content sources for subsequent media selection. Still further, a need exists for a system and a method that establish a default rendering device. Still further, a need exists for a system and a method that associate media playback shortcuts with specific default rendering devices. Still further, a need exists for a system and a method that enable navigation within a collection of content without a need to repeat full content browsing and selection. Still further, a need exists for a system and a method that efficiently create user-defined playback shortcuts using user input facilities of a typical mobile device. Still further, a need exists for a system and a method that automatically create playback shortcuts based on user preferences, user behavior and/or current promotions. Moreover, a need exists for a system and a method that display active metadata tags in a user interface of a multimedia player and playback controller on the mobile device.

### SUMMARY OF THE INVENTION

The present invention generally relates to a system and a method for browsing, selecting and/or controlling rendering of media with a mobile device. More specifically, the present invention relates to a system and a method that aggregate content from multiple content sources, establish a default content source and establish a default rendering device used for subsequent media selection. The system and the method associate media playback shortcuts with specific default rendering devices. Each media playback shortcut may be associated with a default rendering device and/or may be associated with a default playback setting such that the user may utilize the media playback shortcut without the need to select a rendering device or to specify the playback settings. The system and the method enable navigation within a collection of content without a need to repeat full content browsing and selection.

A user interface of a multimedia player and playback controller on the mobile device displays active metadata tags. By selecting one of the active metadata tags, a user may access a list of associated metadata tag values. By selecting one of the metadata tag values, the user may select and/or may render a set of content associated with the selected metadata tag value.

To this end, in an embodiment of the present invention, a method for a user to control media rendering using a mobile device, rendering devices and content sources is provided. Media content objects are available from one or more content sources. The method has the steps of displaying graphic representations on the mobile device wherein each of the graphic representations is associated with a set of the media content objects and further wherein at least one of the graphic representations is associated with a target rendering device of the rendering devices; selecting a first graphic representation of the graphic representations with user input on the mobile device; and rendering the set of the media content objects associated with the first graphic representation on the target rendering device associated with the first graphic representation without user input selecting the target rendering device subsequent to selection of the first graphic representation.

In an embodiment, the method has the steps of establishing a rendering session based on user input on the mobile device which identifies a plurality of the media content objects to be rendered on a first rendering device of the rendering devices in the rendering session; rendering at least one of the plurality of the media content objects on the first rendering device; and creating the first graphic representation based on the rendering session wherein creation of the first graphic representation based on the rendering session associates the first graphic representation with the first rendering device and further wherein creation of the first graphic representation based on the rendering session establishes the plurality of the media content objects as the set of the media content objects associated with the first graphic representation wherein the first graphic representation is created before selection of the first graphic representation.

In an embodiment, the method has the steps of recording a log based on the media content objects rendered by the user over a time period wherein the log records metadata associated with the media content objects rendered by the user over the time period; and creating the first graphic representation based on the log wherein the set of the media content objects associated with the first graphic representation are based on analysis of the metadata recorded in the log.

In an embodiment, the method has the step of associating the first graphic representation with a metadata tag value wherein the set of the media content objects associated with the first graphic representation is determined in response to selection of the first graphic representation by the user and further wherein the set of the media content objects associated with the first graphic representation is determined by matching the metadata tag value to the media content objects available from at least one of the one or more content sources.

In an embodiment, the method has the step of associating the first graphic representation with a rendering setting before selection of the first graphic representation by the user wherein rendering of the set of the media content objects associated with the first graphic representation is based on the rendering setting.

In an embodiment, the method has the steps of presenting controls on the mobile device for selecting an alternate rendering device of the rendering devices based on user input on the mobile device; selecting a second graphic representation of the graphic representations with user input on the mobile device; and rendering the set of the media content objects associated with the second graphic representation wherein the set of the media content objects associated with the second graphic representation are rendered on the alternate rendering device if the alternate rendering device was selected using the controls before selection of the second graphic representation and further wherein the set of the media content objects associated with the second graphic representation are rendered on the target rendering device associated with the second graphic representation if the alternate rendering device was not selected using the controls before the selection of the second graphic representation.

In another embodiment of the present invention, a method for using a mobile device having a user interface to identify a set of media content objects from media content objects available from one or more content sources is provided. The set of media content objects is based on a first media content object having characteristics. The method has the steps of displaying metadata tags associated with the first media content object wherein the mobile device displays the metadata tags and further wherein each of the metadata tags is associated with metadata tag values which represent characteristics of the media content objects available from the one or more content sources; identifying a selected metadata tag of the metadata tags associated with the first media content object wherein the selected metadata tag is identified based on user input on the mobile device; displaying metadata tag values associated with the selected metadata tag wherein the mobile device displays the metadata tag values and further wherein at least one of the metadata tag values which are displayed is at least one of the characteristics of the first media content object; identifying a selected metadata tag value of the metadata tag values wherein the selected metadata tag value is identified based on user input on the mobile device; and identifying the set of media content objects from the media content objects available from the one or more content sources wherein the set of media content objects is identified based on the selected metadata tag value.

In an embodiment, the method has the step of rendering the first media content object wherein rendering of the first media content object is controlled by user input on the mobile device and further wherein the rendering of the first media content object begins before the selected metadata tag is identified.

In an embodiment, the method has the steps of rendering a previous set of media content objects in sequence on a rendering device wherein the first media content object is included in the previous set of media content objects and further wherein the rendering device begins rendering the first media content object before selection of the selected metadata tag; stopping rendering of the previous set of media content objects on the rendering device; and rendering the set of media content objects identified based on the selected metadata tag value.

In an embodiment, the method has the step of displaying the metadata tags on the mobile device concurrently with rendering controls which control rendering of the first media content object on a rendering device.

In an embodiment, the method has the step of presenting a control in the user interface of the mobile device wherein the metadata tags are displayed in response to the user invoking the control.

In an embodiment, the method has the step of displaying the metadata tag values which are the characteristics of the first media content object on the mobile device wherein the metadata tag values which are the characteristics of the first media content object are displayed concurrently with the metadata tags associated with the first media content object.

In an embodiment, the method has the step of displaying a highlighted metadata tag value in the metadata tag values displayed by the mobile device wherein the highlighted metadata tag value is one of the characteristics of the first media content object.

In an embodiment, the method has the step of storing a reference to the set of media content objects wherein the reference is created based on user input on the mobile device and further wherein selection of the reference after the reference is stored enables the user to access the set of media content objects.

In an embodiment, the method has the steps of creating a playback shortcut associated with a rendering device and the selected metadata tag value; displaying the playback shortcut on the mobile device; selecting the playback shortcut wherein a user selects the playback shortcut based on user input on the mobile device; and rendering the set of media content objects in sequence on the rendering device wherein the set of media content objects is determined based on the selected metadata tag value after selection of the playback shortcut by the user.

In an embodiment, the method has the step of presenting scoping controls on the mobile device concurrently with display of the metadata tag values on the mobile device wherein the scoping controls enable a user to modify a scope of the metadata tag values to one of a narrower scope of the metadata tag values and a broader scope of the metadata tag values.

In an embodiment, the method has the step of searching one or more content sources accessible to the mobile device for media content objects having metadata which corresponds to the selected metadata tag value wherein the set of media content objects is determined by searching the one or more content sources.

In an embodiment, at least one of the metadata tags displayed by the mobile device is represented as a graphic icon which visually indicates one or more of the characteristics of the first media content object.

In another embodiment of the present invention, a system for a user to control rendering of media content objects by rendering devices. The media content objects are available from content sources. The system has a mobile device having a user interface; and an application executed by the mobile device wherein the application directs the mobile device to display playback shortcuts and further wherein each of the playback shortcuts is associated with a set of the media content objects wherein at least one of the playback shortcuts is associated with a target rendering device of the rendering devices and further wherein the application directs the target rendering device associated with a selected playback shortcut of the playback shortcuts to render the set of the media content objects associated with the selected playback shortcut in response to user input on the mobile device identifying the selected playback shortcut.

In an embodiment, a rendering session identifies a plurality of the media content objects to be rendered on one of the rendering devices based on user input on the mobile device and further wherein the one of the rendering devices renders at least one of the plurality of the media content objects wherein the application creates a first playback shortcut of the playback shortcuts based on the rendering session and further wherein the target rendering device associated with the first playback shortcut is the one of the rendering devices used in the rendering session wherein the set of the media content objects associated with the first playback shortcut is the plurality of the media content objects used in the rendering session.

In an embodiment, the application associates a first playback shortcut of the playback shortcuts with one or more metadata parameters and further wherein the application determines the set of the media content objects associated with the first media playback shortcut based on the one or more metadata parameters after the mobile device receives the user input identifying the selected playback shortcut.

In an embodiment, the application associates a first playback shortcut of the playback shortcuts with a rendering setting based on user input on the mobile device and further wherein rendering of the set of the media content objects associated with the first playback shortcut is based on the rendering setting.

It is, therefore, an advantage of the present invention to provide a system and a method for browsing, selecting and/or controlling rendering of media with a mobile device.

Another advantage of the present invention is to provide a system and a method that reduce the need for the user to select a content source and/or a rendering device.

And, another advantage of the present invention is to provide a system and a method that establish a default content source used for subsequent media selection tasks.

Yet another advantage of the present invention is to provide a system and a method that aggregate content from multiple content sources for subsequent media selection. Still further, an advantage of the present invention is to provide a system and a method that establish a default rendering device.

And, another advantage of the present invention is to provide a system and a method that associate media playback shortcuts with specific default rendering devices.

Yet another advantage of the present invention is to provide a system and a method that enable navigation within a collection of content without a need to repeat full content browsing and selection.

Still further, an advantage of the present invention is to provide a system and a method that efficiently create user-defined playback shortcuts using user input facilities of a typical mobile device.

And, another advantage of the present invention is to provide a system and a method that automatically create playback shortcuts based on user preferences, user behavior and/or current promotions.

Moreover, an advantage of the present invention is to provide a system and a method that display active metadata tags in a user interface of a multimedia player and playback controller on the mobile device.

Additional features and advantages of the present invention are described in, and will be apparent from, the detailed description of the presently preferred embodiments and from the drawings.

### BRIEF DESCRIPTION OF THE DRAWINGS

FIG. 1 illustrates a system for browsing, selecting and/or controlling rendering of media with a mobile device in an embodiment of the present invention.

FIG. 2 illustrates a system for browsing, selecting and/or controlling rendering of media with a mobile device in an embodiment of the present invention.

FIG. 3 illustrates a flowchart for browsing, selecting and/or controlling rendering of media with a mobile device in an embodiment of the present invention.

FIG. 4 illustrates a user interface in a system for browsing, selecting and/or controlling rendering of media with a mobile device in an embodiment of the present invention.

FIG. 5 illustrates a user interface in a system for browsing, selecting and/or controlling rendering of media with a mobile device in an embodiment of the present invention.

FIG. 6 illustrates a user interface in a system for browsing, selecting and/or controlling rendering of media with a mobile device in an embodiment of the present invention.

FIG. 7 illustrates a user interface in a system for browsing, selecting and/or controlling rendering of media with a mobile device in an embodiment of the present invention.

FIG. 8 illustrates a user interface in a system for browsing, selecting and/or controlling rendering of media with a mobile device in an embodiment of the present invention.

FIG. 9 illustrates a user interface in a system for browsing, selecting and/or controlling rendering of media with a mobile device in an embodiment of the present invention.

### DETAILED DESCRIPTION OF THE PREFERRED EMBODIMENTS

The present invention generally relates to a system and a method for browsing, selecting and/or controlling rendering of media with a mobile device. More specifically, the present invention relates to a system and a method that aggregate content from multiple content sources, establish a default content source and establish a default rendering device used for subsequent media selection and/or rendering. The system and the method associate media playback shortcuts with specific default rendering devices. Each media playback shortcut may be associated with a default rendering device and/or may be associated with a default playback setting such that the user may utilize the media playback shortcut without selecting a rendering device or to specify the playback settings. The system and the method enable navigation within a collection of content without repeating full content browsing and selection.

A user interface of a multimedia player and/or playback controller on the mobile device displays active metadata tags. By selecting one of the active metadata tags, a user may access a list of associated metadata tag values. By selecting one of the metadata tag values, the user may select and/or may render a set of content associated with the selected metadata tag value.

Referring now to the drawings wherein like numerals refer to like parts, FIG. 1 generally illustrates a system 1 for browsing, selecting and/or controlling rendering of media with a mobile device 10. The mobile device 10 may be, for example, a mobile cellular telephone, a personal digital assistant (“PDA”), a 4G mobile device, a 3G mobile device, a 2.5G mobile device, an internet protocol (hereinafter “IP”) video cellular telephone, an ALL-IP electronic device, a satellite radio receiver, a portable digital audio player, a portable digital video player and/or the like. The present invention is not limited to a specific embodiment of the mobile device 10.

The mobile device 10 may have a user interface 20 and/or a multimedia player/controller application 25 (hereinafter “the application 25”). The application 25 may be provided by and/or stored by a computer readable medium, such as, for example, a compact disc, a DVD, a computer memory, a hard drive and/or the like. The computer readable medium may enable the mobile device 10 to execute the application 25.

The system 1 may have a first content source 11, a second content source 12 and/or a third content source 13 (collectively hereinafter “the content sources 11,12,13”). Each of the content sources 11,12,13 may be located within the mobile device 10, such as, for example, in an internal memory, a hard disk and/or a removable storage card or may be accessible to the mobile device 10 via a network. Each of the content sources 11,12,13 may provide various multimedia content objects to a user 15 of the mobile device 10. The user 15 may utilize the system 1, the user interface 20 and/or the application 25 to browse, select, organize and/or render the multimedia content objects. For example, the multimedia content objects may be audio files, video files, digital photos and/or the like. The present invention is not limited to a specific embodiment of the multimedia content objects.

Each of the multimedia content objects may have associated metadata which may be used for browsing, searching, selecting and/or organizing the multimedia content objects. For example, the metadata associated with an audio file may indicate a title, an artist, an album, a track number, a genre, a rating, a recording date, a record label and/or the like. For example, the metadata associated with a video file may indicate a title, a list of one or more actors, a list of one or more character names, a writer, a director, a television station, a movie production company, a name of an associated series, a rating, a production date, a release date and/or the like. For example, the metadata associated with a digital photo may indicate a title, a subject, a list of one or more people in the digital photo, a list of one or more keywords associated with the digital photo, a location, a rating, a date the digital photo was created and/or the like. The metadata associated with the multimedia content objects may indicate a filename associated with the specific multimedia content object and/or a unique identifier associated with the specific multimedia content object. The present invention is not limited to a specific embodiment of the metadata.

The system 1 may have a first rendering device 21, a second rendering device 22 and/or a third rendering device 23 (collectively hereinafter “the rendering devices 21,22,23”). The mobile device 10 may have an internal rendering device. For example, the mobile device 10 may be capable of decoding and/or displaying the video file and/or the digital photo on a visual display on the mobile device 10. As a further example, the mobile device 10 may be capable of decoding and/or rendering the audio file and/or an audio portion of the video file using a speaker connected to the mobile device 10 and/or an audio output port connected to the mobile device 10, such as, for example, a headphone jack.

One or more of the rendering devices 21,22,23 may be an external rendering device that may be external relative to the mobile device 10. The external rendering device may render the multimedia content objects under control of the application 25 of the mobile device 10. The external rendering device may be, for example, a UPnP AV capable television, a UPnP AV capable stereo, a UPnP AV capable digital photo frame, a desktop personal computer, a laptop personal computer, a portable video player, a gaming device, a personal digital assistant, a mobile telephone and/or the like.

The external rendering device may receive rendering instructions from the application 25 of the mobile device 10. The external rendering device may receive the multimedia content objects for rendering from the mobile device 10. The external rendering device may receive multimedia content objects for rendering from one of the content sources 11,12,13 via the network or via an alternative path which does not include the mobile device 10. The external rendering device and the content sources 11,12,13 may communicate via the network; however, a direct connection may also be possible, such as, for example, a Bluetooth connection, a USB cable and/or the like. The mobile device 10 and the external rendering device may communicate via the network; however, a direct connection may also be possible, such as, for example, a Bluetooth connection, a USB cable and/or the like. The present invention is not limited to a specific means of communication between the mobile device 10 and the external rendering device or a specific means of communication between the external rendering device and the content sources 11,12,13.

FIG. 2 generally illustrates an embodiment of the system 1 for browsing, selecting and/or controlling rendering of media with the mobile device 10. In the embodiment depicted in FIG. 2, the first content source 11 is located internal to the mobile device 10. For example, the first content source 11 may be an internal memory of the mobile device 10, an internal hard disk of the mobile device 10, a removable storage card connected to the mobile device 10 and/or the like. The first rendering device 21 is also depicted as located internally to the mobile device 10. An internal location of the first rendering device 21 may enable the multimedia content objects to be rendered directly on the mobile device 10. For example, visual content may be viewed on a display screen connected to the mobile device 10, and/or audio content may be rendered by a speaker connected to the mobile device 10 and/or to headphones attached to the mobile device 10.

The second content source 12 and/or the second rendering device 22 may have a direct connection to the mobile device 10. Thus, the second content source 12 and/or the second rendering device 22 may communicate with the mobile device 10 without using a network 30. For example, the second content source 12 may be a content server application running on a laptop personal computer to which the mobile device may connect via a wireless data connection, such as, for example, a Bluetooth connection, an infrared connection and/or the like, and/or a wired data connection, such as, for example, a USB cable connection and/or the like. The mobile device 10 may communicate with the second rendering device 22 via a wireless data connection, such as, for example, a Bluetooth connection, an infrared connection and/or the like, and/or a wired data connection, such as, for example, a USB cable connection and/or the like.

The third content source 13 and/or the third rendering device 23 may be connected to the mobile device 10 via a network 30. The network 30 may be a home network based on Wi-Fi technology, wired ethernet technology and/or other home networking technology. For example, the network 30 may be the internet. The network 30 may be a mobile carrier network, such as a 2.5G mobile network, a 3G mobile network, a 4G mobile network and/or the like. The network 30 may be a composite network that may utilize multiple network technologies. The mobile device 10 may connect to the third content source 13 and the third rendering device 23 via different networks. For example, a connection between the mobile device 10 and the third content source 13 may utilize the same network technologies and/or different network technologies than a connection between the mobile device 10 and the third rendering device 23.

For example, if the mobile device 10 has Wi-Fi connection capability, the third content source 13 may be a UPnP AV capable media server that may be connected to the mobile device 10 via a home Wi-Fi network. As another example, the third content source 13 may be a media server located outside of the home network, and/or the mobile device 10 may access the third content source 13 from the home Wi-Fi network via the internet. As yet another example, the third content source 13 may be a content service operated by a mobile carrier, and/or the mobile device 10 may access the third content source 13 via a mobile carrier network, such as, for example, a 3G mobile network. For example, the third rendering device 23 may be a UPnP AV capable television, a UPnP AV capable stereo system, a UPnP capable digital photo frame, a networked video gaming console and/or other device accessible to the mobile device 10 via the network 30. The present invention is not limited to specific locations of the content sources 11,12,13 and/or specific locations of the rendering devices 21,22,23. Further, the present invention is not limited to specific connections by which the mobile device 10, the content sources 11,12,13 and/or the rendering devices 21,22,23 may communicate.

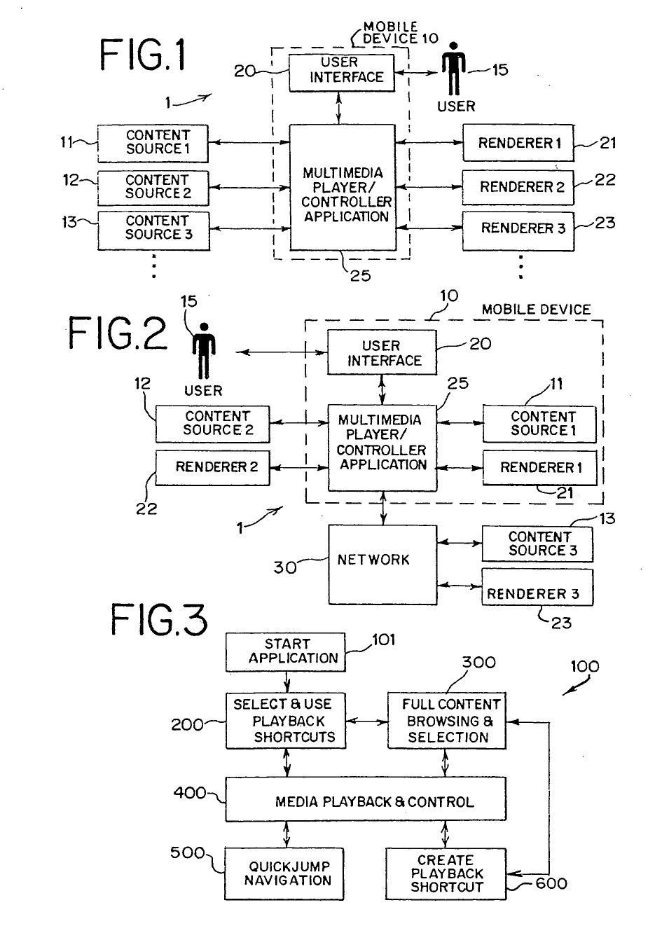

FIG. 3 generally illustrates a method 100 for browsing, selecting and/or controlling rendering of media with a mobile device. As generally shown at step 101, the user 15 of the mobile device 10 may initiate use of the application 25. The application 25 may provide a “Select and Use Playback Shortcuts” step 200. In the “Select and Use Playback Shortcuts” step 200, available multimedia playback shortcuts may be provided to the user 15, and/or the user 15 may select one of the available multimedia playback shortcuts. The user 15 may use a default rendering device previously associated with a selected multimedia playback shortcut. Alternatively, the user 15 may select one of the available rendering devices for rendering. Thus, the user 15 may quickly initiate rendering of multimedia content objects associated with the multimedia playback shortcuts.

The user 15 may not select any of the available multimedia playback shortcuts and/or may instead select multimedia content objects via a “Full Content Browsing and Selection” step 300. The “Full Content Browsing and Selection” step 300 may enable the user 15 to browse a hierarchy of multimedia content objects available from one or more of the content sources. The “Full Content Browsing and Selection” step 300 may enable the user 15 to enter search terms and/or filter terms to determine, to select and/or to organize available multimedia content objects for rendering. The user 15 may initiate rendering of selected multimedia content objects by a previously configured default rendering device, or the user may select one or more of the rendering devices for rendering.

Therefore, the user may have two alternative methods for initially selecting the multimedia content objects for rendering and/or a corresponding rendering device: a method based on the media playback shortcuts, namely the “Select and Use Playback Shortcuts” step 200, and/or a browsing method which may enable complete rendering control via selection of individual multimedia content objects from among a full set of multimedia content objects available from all of the content sources, namely the “Full Content Browsing and Selection” step 300.

After the user 15 selects one or more of the multimedia content objects and/or a rendering device, the user 15 may proceed to a “Media Playback and Control” step 400. For example, the user 15 may proceed to the “Media Playback and Control” step 400 after the “Select and Use Playback Shortcuts” step 200 and/or the “Full Content Browsing and Selection” step 300. In the “Media Playback and Control” step 400, the user 15 may control rendering of the selected multimedia content. The user interface 20 of the mobile device 10 may indicate current rendering status information and/or may provide rendering controls to enable the user 15 to control rendering.

The current rendering status information may have an indication of which rendering device is currently rendering the multimedia content object, metadata associated with the multimedia content object currently being rendered, a graphic icon associated with the multimedia content object currently being rendered, an indication of a current play time, a total play time and/or a remaining play time for the multimedia content object currently being rendered and/or the like. The rendering controls may be play, pause, stop, rewind, fast-forward, move to a previous content object, move to a next content object, a “mute” mode, a “shuffle” mode, a “repeat” mode and/or the like.

For example, if the multimedia content object is currently rendering on an internal rendering . . . device of the mobile device 10, the user 15 may view rendered content on a mobile device display and/or may hear rendered content on a speaker connected to the mobile device 10 and/or on a headphone device which may be connected to the mobile device 10. A connection between the mobile device 10 and the headphone device may be wired or wireless depending on capability of the mobile device 10.

In the “Media Playback and Control” step 400, the system 1, the user interface 20 and/or the application 25 may provide rendering device selection controls that enable the user 15 to select from the available rendering devices. Each of the available rendering devices may be associated with a set of selected multimedia content objects, a set of associated rendering status information and/or a set of playback controls. Thus, functionality of the “Media Playback and Control” step 400 may depend on which of the available rendering devices the user 15 selects using the rendering device selection controls. The playback controls may be used to control the rendering device which the user 15 has most recently selected using the rendering device selection controls. Further, the user 15 may select a specific rendering device and then may utilize either the “Select and Use Playback Shortcuts” step 200 or the “Full Content Browsing and Selection” step 300 to select one or more of the available multimedia content objects to be rendered on the selected rendering device.

By repeating these steps, the user 15 may select multiple sets of multimedia content objects to be rendered on multiple rendering devices, and/or the user 15 may initiate rendering of each set of multimedia content objects on a selected rendering device. Thus, the user 15 may direct multiple rendering devices to simultaneously render multiple different sets of multimedia content objects. Alternatively, the user 15 may direct multiple rendering devices to simultaneously render the same set of multimedia content objects in a synchronized manner.

In addition, the user 15 may obtain the rendering status information associated with the available rendering devices by selecting a specific rendering device using the rendering selection controls provided by the system in the “Media Playback and Control” step 400. Further, the user 15 may control rendering by the rendering devices by selecting a specific rendering device using the rendering selection controls provided by the system 1 in the “Media Playback and Control” step 400.

The system 1, the user interface 20 and/or the application 25 may provide a “QuickJump Navigation” step 500 which may enable the user 15 to navigate through the available multimedia content objects and/or to choose a new set of selected multimedia content objects to be rendered by the currently selected rendering device. The “QuickJump Navigation” step 500 may be based on navigation along “metadata axes” which correspond to the metadata associated with the multimedia content objects. The “QuickJump Navigation” step 500 may utilize active metadata tags which may enable the user 15 to select a characteristic of the multimedia content object currently being rendered. Selection of the characteristic may enable selection of the multimedia content objects which have metadata that corresponds to the characteristic selected by the user 15. The active metadata tags may be the metadata associated with the multimedia content object currently being rendered, and/or the active metadata tags may be displayed by the user interface 20 of the mobile device 10. Further, each of the active metadata tags may be selected by the user 15 within the “QuickJump Navigation” step 500. Thus, the active metadata tags may inform the user 15 about the multimedia content object currently being rendered and/or may enable the user 15 to invoke the “QuickJump Navigation” step 500 along one of the metadata axes.

For example, one of the active metadata tags may be selected by a button which the user 15 may select using a finger press and/or a stylus click if the mobile device 10 has a touch-screen. Alternatively, the user 15 may select one of the active metadata tags using a joystick, a trackball, a 5-way directional switch, an up/down directional switch, a softkey and/or other user input means connected to the mobile device 10. The rendering status information displayed to the user 15 in the “Media Playback and Control” step 400 may indicate the active metadata tags. If the rendering status information indicates the active metadata tags, the user 15 may proceed to the “QuickJump Navigation” step 500 from the “Media Playback and Control” step 400 by selecting one of the active metadata tags. If the “Media Playback and Control” step 400 does not indicate the active metadata tags, the user may utilize a button, a softkey option, a menu option and/or other user input means to move from the “Media Playback and Control” step 400 to the “QuickJump Navigation” step 500. The active metadata tags may be displayed by and/or may be selected in the “QuickJump Navigation” step 500.

If the user 15 selects one of the active metadata tags, the “QuickJump Navigation” step 500 may display a list of various metadata tag values associated with the selected active metadata tag. One of the metadata tag values displayed by the list may be a metadata tag value associated with the multimedia content object currently being rendered. The user 15 may select the metadata tag value corresponding to the multimedia content object currently being rendered to replace the set of selected multimedia content objects. The multimedia content objects which are associated with metadata that match the metadata tag value associated with the multimedia content object currently being rendered may replace the set of selected multimedia content objects. Alternatively, the user 15 may select one of the other metadata tag values associated with the selected active metadata tag to replace the set of selected multimedia content objects with the multimedia content objects which are associated with metadata that match the metadata tag value selected by the user 15.

The “QuickJump Navigation” step 500 may be based on similarity of metadata to the selected value rather than an exact match of metadata to the selected value. For example, the system 1 may provide a “similar value” option that enables the user 15 to replace the set of selected multimedia content objects with the multimedia content objects which are associated with metadata that are similar to the value selected by the user 15.

If the user 15 selects one of the metadata tag values, the set of multimedia content objects being rendered by the selected rendering device may be replaced by a new set of multimedia content objects. For example, the new set of multimedia content objects may be the multimedia content objects which are associated with metadata that correspond to the metadata tag value selected by the user 15. The selected rendering device may initiate rendering of the new set of multimedia content objects, and/or the user 15 may be returned to the “Media Playback and Control” step 400.

The user 15 may define a new media playback shortcut by using a “Create Playback Shortcut” step 600 that may be selected from the “Media Playback and Control” step 400. The new media playback shortcut may be associated with the set of multimedia content objects selected in the “Media Playback and Control” step 400. For example, the set of multimedia content objects may have been previously selected by the user 15 using the “Select and Use Playback Shortcuts” step 200, the “Full Content Browsing and Selection” step 300, the “QuickJump Navigation” step 500, combinations and/or repetitions of any of these steps, and/or another method by which the user 15 may have previously selected the multimedia content objects. The set of multimedia content objects associated with the new media playback shortcut may be the only set of multimedia content objects currently selected for rendering. Alternatively, the set of multimedia content objects associated with the new media playback shortcut may be one of a plurality of sets of multimedia content objects selected for rendering to different rendering devices.

If the set of multimedia content objects associated with the new media playback shortcut is one of a plurality of sets of multimedia content objects selected for rendering to different rendering devices, the set of multimedia content objects associated with the rendering device which was most recently selected may then be associated with the new media playback shortcut. For example, the rendering device which was most recently selected may have been selected using the rendering device selection controls available in the “Media Playback and Control” step 400.

In the “Create Playback Shortcut” step 600, the system 1, the user interface 20 and/or the application 25 may enable the user 15 to provide a name for the new playback shortcut. A default name may be provided by the system, and/or the user 15 may accept, may modify and/or may replace the default name. The user 15 may select a default rendering device to be associated with the new playback shortcut. For example, the default rendering device may be the rendering device which is currently rendering or which has been selected to render the set of multimedia content objects to be associated with the new media playback shortcut. Alternatively, the user 15 may select the default rendering device for the new media playback shortcut from a list of available rendering devices. The user 15 may specify that no default rendering device is associated with the new media playback shortcut. For the new media playback shortcut, the user 15 may specify a default shuffle mode, such as, for example, shuffle “on” or shuffle “off”; a default repeat mode, such as repeat “on” or repeat “off”; and/or other default parameters.

After the user 15 completes the “Create Playback Shortcut” step 600, the system 1, the user interface 20 and/or the application 25 may return the user 15 to the “Media Playback and Control” step 400 in which the rendering of the set of multimedia content objects by the selected rendering device may continue. The new media playback shortcut may be utilized in subsequent uses of the “Select and Use Playback Shortcuts” step 200.

The system 1, the user interface 20 and/or the application 25 may provide a “Configuration” function which may enable the user 15 to specify one or more of the content sources to be used for content selection. The “Select and Use Playback Shortcuts” step 200, the “Full Content Browsing and Selection” step 300 and/or the “QuickJump Navigation” step 500 may involve content selection for which the “Configuration” step may be employed. For example, the user 15 may specify that content selection should be limited to two content sources of four available content sources. As a result, content selection performed in other steps may be limited to the multimedia content objects which are available from the two content sources specified by the user 15 via the “Configuration” function. If multiple content sources are available and/or are specified by the user 15, content selection may aggregate multimedia content objects which may be available from the multiple content sources. The user 15 may select the multimedia content objects from an aggregated set of multimedia content objects. If the user 15 does not specify a limitation using the “Configuration” function, content selection may aggregate multimedia content objects from all of the available content sources.

The “Configuration” function may enable the user 15 to define a global default rendering device to be used if the user 15 initiates rendering of selected multimedia content objects without selecting a rendering device. The “Configuration” function may enable the user 15 to specify other preferences, other settings and/or other defaults.

For example, the user 15 may initially use the “Select and Use Playback Shortcuts” step 200 to utilize a jazz music playback shortcut. As a result, a set of audio file content objects associated with a genre of jazz music may be provided by the system. The system may render the set of audio file content objects associated with the genre of jazz music on a UPnP AV capable stereo system which may have been previously associated with the jazz music playback shortcut as the default rendering device for the media playback shortcut. Thus, the user 15 may initiate rendering of the audio file content objects associated with the jazz music playback shortcut by the default rendering device for the jazz music playback shortcut.

The system 1, the user interface 20 and/or the application may enable the user 15 to change the selected set of multimedia content objects playing to the UPnP AV capable stereo by using the “QuickJump Navigation” step 500. As discussed previously, the user interface 20 may display the active metadata tags with the rendering status information. For example, during rendering, the user interface 20 may display the following active metadata tags: “Title: Lazy Bird”, “Artist: John Coltrane”, “Album: Blue Train”, “Genre: Jazz” and/or “Recorded: May 15, 1957.”

In the present example, the user 15 may select the active metadata tag for “Artist: John Coltrane” to be directed to the “QuickJump Navigation” step. As a result, the system may provide a list of artists. The list may have “John Coltrane” as a highlighted artist to indicate that John Coltrane is the artist for the multimedia content object currently being rendered. The list of artists may encompass artists from a database of known artists, artists associated with a currently selected genre e.g. jazz music in the present example, artists associated with multimedia content objects located in the currently selected set of multimedia content objects and/or another restricted set of artists. The present invention is not limited by the method of generating and/or restricting the list of metadata tag values displayed to the user 15.

In the present example, limitations of the user interface 20 of the mobile device 10 may restrict a visible portion of the list of artists. Thus, the system may display the following partial list and/or may provide up/down scrolling options available to expose remaining portions of the list:

[...]
Dave Brubeck
Ornette Coleman
>>John Coltrane<<
Miles Davis
Dizzy Gillespie
[...]

The user 15 may invoke a “Select and Play” function based on the initially highlighted entry “John Coltrane”. As a result, the set of multimedia content objects selected for rendering by the UPnP AV stereo system may be changed to a new set of multimedia content objects. The new set of multimedia content objects may be the available multimedia content objects associated with an “Artist” metadata tag of “John Coltrane.” The new set of multimedia content objects is rendered by the UPnP AV stereo system, and/or the user 15 is returned to the “Media Playback and Control” step 400.

The user 15 may select a different value from the list of artists presented by the “QuickJump Navigation” step 500. For example, the user 15 may select “Dizzy Gillespie” from the list and/or may select the “Select and Play” function based on “Dizzy Gillespie.” As a result, the set of multimedia content objects selected for rendering by the UPnP AV stereo system are changed to a new set of multimedia content objects. The new set of multimedia content objects may be the available multimedia content objects associated with an “Artist” metadata tag of “Dizzy Gillespie.” The new set of multimedia content objects is rendered by the UPnP AV stereo system, and/or the user 15 is returned to the “Media Playback and Control” step 400.

As the available multimedia content objects associated with an “Artist” metadata tag of “Dizzy Gillespie” are rendered, the user 15 may utilize the “Create Playback Shortcut” step 600 to create a new media playback shortcut associated with the selected multimedia content objects. The user 15 may provide “DizzyG” as the name for the new media playback shortcut. The user 15 may specify that the default shuffle mode should “shuffle on” for the new media playback shortcut. The user 15 may confirm that the UPnP AV stereo system currently rendering the selected multimedia content objects is the default rendering device for the new media playback shortcut. The new media playback shortcut will be available when the “Select and Use Playback Shortcuts” step 200 is subsequently executed. Thus, the user 15 may create a fast and efficient way to select and/or to initiate playback of Dizzy Gillespie songs using the media playback shortcut. In a preferred embodiment, the user 15 may utilize the shortcut using a single action of user input in the “Select and Use Playback Shortcuts” step 200 which may provide a first screen presented to the user 15 during use of the system 1, the user interface 20 and/or the application 25. Additional details for the “Select and Use Playback Shortcuts” step 200, the “Full Content Browsing and Selection” step 300, the “Media Playback and Control” step 400, the “QuickJump Navigation” step 500 and the “Create Playback Shortcut” step 600 are provided hereafter with additional usage examples.

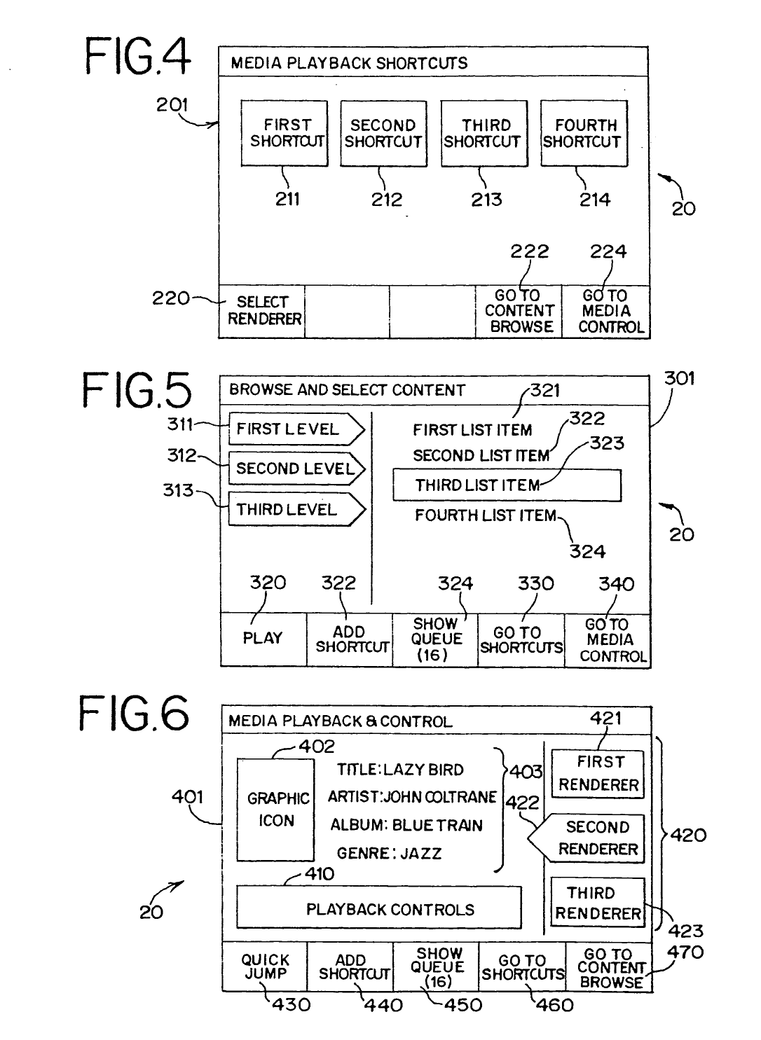

FIG. 4 generally illustrates an embodiment of the user interface 20 for the “Select and Use Playback Shortcuts” step 200 in an embodiment of the present invention. FIG. 4 is a functional drawing which shows information and controls which may be presented to and/or may be used by the user 15 of the mobile device at a corresponding step of use of the system. The drawings do not limit the present invention to a specific layout of information and/or controls. Functional control elements may have various embodiments depending on the capabilities of the mobile device. For example, a particular control may take the form of a touch button or touch control on a mobile device with a touchscreen, a soft key on a mobile device which supports soft keys, a graphic element which may be selected by a joystick, a trackball, a 5-way navigation switch, an up/down rocker switch and/or the like. One skilled in the art will recognize numerous common user interface elements which may be used in a specific embodiment.

The system 1, the user interface 20 and/or the mobile device 10 may provide a “Select and Use Playback Shortcuts” screen 201. In the “Select and Use Playback Shortcuts” step 200, the system 1, the user interface 20 and/or the application 25 may provide a list of media playback shortcuts which may be employed by the user 15. For example, the system 1, the user interface 20 and/or the application 25 may provide a first media playback shortcut 211, a second media playback shortcut 212, a third media playback shortcut 213 and/or a fourth media playback shortcut 214 (collectively hereinafter “the media playback shortcuts 211,212,213,214”). A number of displayed media playback shortcuts may vary depending on how many media playback shortcuts were created by the user 15 and/or the system 1. If a list of media playback shortcuts exceeds a display capacity of the user interface 20 and/or the mobile device 10, the user interface 20 may provide a scrolling mechanism, a set of multiple pages of shortcuts and/or a similar mechanism to enable the user 15 to view and/or to select from all of the available media playback shortcuts. Each of the media playback shortcuts 211,212,213,214 may be associated with a set of multimedia content objects which may be rendered by selecting a corresponding media playback shortcut.

If the media playback shortcut was created from a set of multimedia content objects which the user 15 selected object-by-object, the set of multimedia content objects associated with the corresponding media playback shortcut may be specified by a fixed list of multimedia content objects. For example, the user 15 may have selected individual multimedia content objects using the “Full Content Browsing and Selection” step 300, and/or the user 15 may have created a new media playback shortcut based on the selected set of multimedia content objects.

Alternatively, the set of multimedia content objects associated with a media playback shortcut may be specified by a set of metadata parameters. For example, the user 15 may utilize the “QuickJump Navigation” step 500 to specify a set of multimedia content objects that may be audio files associated with a rock music genre which have a recording date between Jan. 1, 1950 to Dec. 31, 1959, and the user 15 may have then created a new media playback shortcut entitled “50's Rock”. In this case, the metadata parameters specified by the user 15 in the “QuickJump Navigation” step 500 may be associated with the media playback shortcut. Thus, the system 1 may retrieve a set of multimedia content objects having metadata corresponding to the parameters if the media playback shortcut is selected. Therefore, selection of the media playback shortcut may provide an updated set of multimedia content objects even if some of the multimedia content objects were not available when the media playback shortcut was created. For example, the updated set of multimedia content objects may reflect availability of a new multimedia content object and/or a new content source.

As a further alternative, a media playback shortcut may be associated with one or more multimedia content objects regularly updated by a content service. For example, the media playback shortcut may be associated with current news reports, current sports highlights and/or a current episode of a user-specified favorite television show.

The system 1 may create automatically-generated media playback shortcuts which may be presented to the user 15 in the “Select and Use Playback Shortcuts” step 200. The automatically-generated media playback shortcuts may be displayed with user-defined media playback shortcuts; in a separate area of the user interface 20 of the mobile device from the user-defined media playback shortcuts; on a separate screen, sub-menu and/or sub-step accessible from the “Select and Use Playback Shortcuts” step 200; and/or the like.

The automatically-generated media playback shortcuts may be created based on user preferences. For example, the system may obtain content preferences from the user 15, such as, for example, preferences for types of content, content genres, favorite artists, favorite television shows and/or the like. For example, the system 1 may obtain the content preferences using a content preferences page and/or a questionnaire completed by the user 15. As a result, the system 1 may create the automatically-generated media playback shortcuts to correspond to the content preferences indicated by the user 15. The user 15 may edit the content preferences. For example, the user 15 may subsequently re-visit the content preferences page and/or the questionnaire to update and/or to change the content preferences. In response, the system 1 may update and/or may change the automatically generated media playback shortcuts which may be available at the “Select and Use Playback Shortcuts” step 200.

The automatically-generated media playback shortcuts may be created based on multimedia content objects previously selected by the user 15. For example, the system 1 may create and/or may maintain an automatically-generated media playback shortcut corresponding to a most recent set of multimedia content objects selected for rendering. The system 1 may create and/or may maintain a plurality of the automatically-generated media playback shortcuts corresponding to the most recent sets of multimedia content objects selected for rendering. The system 1 may create and/or may maintain an automatically-generated media playback shortcut corresponding to a recent set of multimedia content objects selected via the “QuickJump Navigation” step 500. The system 1 may use the multimedia content objects which are selected and/or rendered by the user 15 and/or corresponding metadata to create the automatically-generated media playback shortcuts.

The system 1 may maintain a log of the multimedia content objects selected and/or rendered by the user 15, and/or the system 1 may use the log to determine specific content types, content genres, favorite artists, favorite television shows and/or the like for which the user 15 may have a preference. The system 1 may generate histograms of metadata tag values to determine specific tag values for which the user 15 may have a preference.

For example, the system 1 may generate a two-dimensional histogram of genre and recording date over time based on the metadata tag values for genre and recording date corresponding to multimedia content objects selected and/or rendered by the user 15. The system 1 may use known techniques to search for peaks in the histogram and may determine that the user 15 has exhibited a preference for rock music from the 1980's. The system 1 may proceed to create an automatically-generated shortcut associated with audio files that have metadata corresponding to parameters of rock music from the 1980's. The system 1 may create a name for the automatically-generated media playback shortcut based on the parameters. For example, the system 1 may create a name for the automatically-generated media playback shortcut based on the genre and the dates at which the histogram peak occurred. For example, the automatically-generated media playback shortcut may be displayed with the name of “80's Rock” in the “Select & Use Playback Shortcuts” step.

As another example, the system 1 may create a histogram for video files which have associated “TV Series” metadata. The system 1 may use the histogram to determine television shows for which the user 15 may have a preference. The system 1 may proceed to create one or more automatically-generated media playback shortcuts associated with the television shows for which the user 15 may have a preference. The system 1 may use a name of the TV Series as the name of the media playback shortcut. The system 1, the user interface 20 and/or the application 25 may display a graphic image associated with the TV Series as a graphic depiction of the shortcut when the media playback shortcut is displayed in the “Select and Use Playback Shortcuts” step 200.

The automatically-generated media playback shortcut may be based on current content highlights and/or current promotions which may be available from an accessible content service. For example, the mobile device may be connected to the content service via the internet, a mobile carrier network and/or other available connection. The content service may act as a content source and/or may provide multimedia content objects and associated metadata to the mobile device. The content service may provide the current content highlights and/or the current promotions which may identify recommended multimedia content objects available from the content service. The current content highlights and/or the current promotions may change and/or may be based on information available to the content service. The content service may communicate with the system to define a media playback shortcut which corresponds to the recommended multimedia content objects available from the content service. The system may create a corresponding automatically-generated media playback shortcut which may be displayed in the “Select and Use Playback Shortcuts” step 200.

For example, the content service may have a promotion associated with a first game of the World Series. The promotion may have a first video file with highlights from the season of the National League team, a second video file with highlights from the season of the American League team and/or a third video file which provides “pre-game” commentary for the first game of the World Series. The content service may communicate with the system to specify a name for a promotional automatically-generated media playback shortcut, such as, for example, “World Series Opener.” The promotional automatically-generated media playback shortcut may enable the user 15 of the mobile device 10 to access and/or to retrieve the first video file, the second video file and/or the third video file. The system 1 may create an automatically-generated media playback shortcut with the name “World Series Opener” which may be displayed in the “Select and Use Playback Shortcuts” step 200. The automatically-generated media playback shortcut with the name “World Series Opener” may be associated with the first video file, the second video file and/or the third video file.

Each of the media playback shortcuts 211,212,213,214 may be associated with a default rendering device and/or default settings, such as, for example, a default “Shuffle Mode” setting, a default “Repeat Mode” setting, a default time spacing for displaying photographs in a slide show mode and/or additional default settings. If the user 15 selects one of the media playback shortcuts 211,212,213,214, the system 1 may render the corresponding set of multimedia content objects using the default rendering device and/or the default settings.

The media playback shortcuts 211,212,213,214 may be displayed using a name which may have been specified by the user 15 and/or by the system 1 when the media playback shortcut was created. Each of the media playback shortcuts 211,212,213,214 may be displayed with an associated graphic icon which may provide information about the multimedia contents associated with the media playback shortcut and/or about a method of creation of the media playback shortcut. For example, media playback shortcuts which are associated with music files may be accompanied by an icon which indicates music and/or audio to distinguish the media playback shortcuts which are associated with music files from media playback shortcuts associated with video and/or photo files. As another example, a media playback shortcut which has episodes of a particular television series may be accompanied by an icon which depicts a graphic image associated with the television series. As yet another example, the automatically-generated media playback shortcuts may be distinguished from the user-generated media playback shortcuts by using different graphic icons.

The “Select and Use Playback Shortcuts” step 200 may provide functions for editing and/or functions for organizing the media playback shortcuts. For example, the functions for editing the media playback shortcuts may be changing the name of one of the media playback shortcuts, changing an appearance of one of the media playback shortcuts, changing the default rendering device associated with one of the media playback shortcuts, changing the default settings associated with one of the media playback shortcuts and/or the like. For example, the functions for organizing the media playback shortcuts may be moving the media playback shortcuts, grouping the media playback shortcuts, changing a display order of the media playback shortcuts, deleting one or more of the media playback shortcuts, hiding one or more of the media playback shortcuts and/or the like.

In addition, the system 1 may provide sorting modes for the media playback shortcuts. For example, the media playback shortcuts may be sorted based, on associated media types, alphabetical ordering of the names of the media playback shortcuts, a frequency of use and/or of access of the media playback shortcuts, a date and/or a time of creation of the media playback shortcuts and/or the like.

The media playback shortcuts may be displayed with an indication of the default settings associated with the media playback shortcuts. For example, a media playback shortcut associated with a default rendering device may be displayed with an indication that a default rendering device exists and/or with a textual and/or graphical depiction of the default rendering device. Thus, the user 15 may distinguish which of the media playback shortcuts may be rendered without selecting one of the available rendering devices. A visual indication may be displayed to indicate the default “Shuffle Mode” setting, the default “Repeat Mode” setting, the default time spacing for slide show display of photographs and/or the other default settings which may be associated with the media playback shortcuts.

The system 1, the user interface 20 and/or the application 25 may enable the user 15 to select one of the available media playback shortcuts 211,212,213,214. If the selected media playback shortcut is associated with a default rendering device or if only one rendering device is available, then the system 1 may proceed without further input from the user 15. The system 1 may initiate rendering of the set of multimedia content objects associated with the media playback shortcut by the corresponding rendering device. The system 1 may proceed to the “Media Playback & Control” step to indicate to the user 15 that rendering was initiated and/or to enable the user 15 to control the rendering.

If the user 15 selects a media playback shortcut which does not have an associated default rendering device, the system may prompt the user 15 to select one of the available rendering devices to render the selected media playback shortcut. After one of the available rendering devices is selected, the system 1 may initiate rendering of the set of multimedia content objects associated with the media playback shortcut by the selected rendering device, and/or the system 1 may proceed to the “Media Playback and Control” step 400.

In the “Select and Use Playback Shortcuts” step 200, the system 1, the user interface 20 and/or the application 25 may enable the user 15 to select one of the available rendering devices before the user 15 selects one of the media playback shortcuts 211,212,213,214. For example, the user 15 may select a “Select Renderer” function 220 that may be provided by the system on the user interface 20. The rendering device selected using the “Select Renderer” function 220 may override the default rendering device which may be associated with the media playback shortcut subsequently selected by the user 15. Thus, the user 15 may use the media playback shortcut with the associated default rendering device or may use the media playback shortcut using an alternative rendering device selected by the user 15.

The “Select and Use Playback Shortcuts” step 200 may have additional options to navigate to other available steps. For example, the system 1, the user interface 20 and/or the application 25 may provide a “Go To Content Browse” option 222 to proceed to the “Full Content Browsing and Selection” step 300. The “Go To Content Browse” option 222 may enable the user 15 to select multimedia content objects using the “Full Content Browsing and Selection” step 300 instead of using one of the media playback shortcuts. As another example, there may be a “Go To Media Control” option 224 to proceed to the “Media Playback and Control” step 400. The “Go To Media Control” option 224 may enable the user 15 to view and/or to control the sets of multimedia content objects currently being rendered by the various rendering devices instead of selecting a new set of multimedia content objects by using one of the media playback shortcuts. Other functions and/or other navigation options in the “Select and Use Playback Shortcuts” step 200 not shown in FIG. 4 may also be available.

FIG. 5 generally illustrates an embodiment of the user interface 20 for the “Full Content Browsing and Selection” step 300 in an embodiment of the current invention. FIG. 5 is a functional drawing which shows information and controls which may be presented to and/or may be used by the user 15 of the mobile device 10 at a corresponding step of use of the system 1. As discussed previously, the drawings do not limit the present invention to a specific layout of information and/or controls. Functional control elements may have various embodiments depending on the capabilities of the mobile device 10.

The system 1, the user interface 20 and/or the application 25 may provide a “Full Content Browsing and Selection” screen 301. At the “Full Content Browsing and Selection” step 300, the system 1, the user interface 20 and/or the application 25 may display a hierarchy by which the multimedia content objects are organized within one of the content sources and/or by which the system indicates multimedia content objects aggregated from a plurality of the available content sources. If the user 15 selected one or more content sources to be queried in subsequent browse operations, functions of the “Full Content Browsing and Selection” step 300 are applied to the content sources selected by the user 15. Alternatively, the system may aggregate the multimedia content objects from all of the available content sources and/or may not enable the user 15 to select one or more content sources to be queried in subsequent browse operations. The invention is not limited to a particular embodiment of the “Full Content Browsing and Selection” screen 301.

In the “Full Content Browsing and Selection” step 300, the system 1, the user interface 20 and/or the application 25 may display a set of hierarchy level tags. For example, the user interface 20 may display a First Level tag 311, a Second Level tag 312 and/or a Third Level tag 313 (collectively hereinafter “the hierarchy level tags 311,312,313”). The hierarchy level tags 311,312,313 may indicate a currently selected path into the hierarchy by which the multimedia content objects are organized, such as, for example, a directory hierarchy, a content organization hierarchy and/or other logical hierarchy by which the multimedia content objects may be arranged for browsing.

In the “Full Content Browsing and Selection” step 300, the system 1, the user interface 20 and/or the application 25 may display a list of the multimedia content objects available at a corresponding level of the hierarchy. For example, the user interface 20 may display a First List Item 321, a Second List Item 322, a Third List Item 323 and/or a Fourth List Item 324 (collectively hereinafter “the list items 321,322,323,324”). For example, the list items 321,322,323,324 may represent multimedia content objects, such as, for example, music files, video files, digital photographs and/or playlists, and/or may represent object containers which may be further levels of the hierarchy.

For example, the system 1, the user interface 20 and/or the application 25 may present multimedia content objects in a first level of the hierarchy according to multimedia content object type, such as, for example, music files, video files, and digital photos. If the user 15 selects the music files, the system 1, the user interface 20 and/or the application 25 may provide a second level of the hierarchy. For example, the second level of the hierarchy may enable the user 15 to browse the music files by genre, by artist, by album name and/or the like. If the user 15 selects to browse by genre, the system 1, the user interface 20 and/or the application 25 may provide a third level of the hierarchy. For example, the third hierarchy may enable the user to select from various genres, such as, for example, alternative, classical, country, jazz, rock and/or the like.

For example, the user 15 may browse the hierarchy by selecting object containers for “music files,” then “genre” and then “country” to view a list of available country music files. The hierarchy level tags 311,312,313 may then be displayed as “music files” for the First Level tag 311, “genre” for the Second Level tag 312 and/or “country” for Third Level tag 313. The user interface 20 may display a list of multimedia objects having music files associated with the genre of country music.

The system 1, the user interface 20 and/or the application 25 may enable the user 15 to select one or more of the multimedia content objects from a list of available objects. The list of available objects may indicate the multimedia content objects that have been selected to display which of the multimedia content objects have been added to a current set of selected multimedia content objects. The user 15 may select a multimedia content object container from the list of available objects. If the user 15 selects a multimedia content object container, the user 15 may proceed to another level of the hierarchy, and/or the user interface 20 may display a name of the object container as a new hierarchy level tag.

The hierarchy level tags 311,312,313 may provide a visual indication of where the user 15 is browsing in the content organization hierarchy. The hierarchy level tags 311,312,313 may also provide navigation of the hierarchy. For example, the hierarchy level tags 311,312,313 may be selected by the user 15 to move to a specific location and/or a specific level of the hierarchy. To continue the previous example in which the hierarchy level tags 311,312,313 may be displayed as “music files” for the First Level tag 311, “genre” for the Second Level tag 312 and “country” for Third Level tag 313, the user 15 may select the First Level tag 311 to view the multimedia content objects located in a music files container. The user 15 may then select from a list of available multimedia content objects and/or object containers, such as, for example, “Genre,” “Artist,” “Album Name,” and/or the like. Thus, the user 15 may browse for music files by genre, by artist name, by album names and/or the like.

The user 15 may employ the hierarchy level tags 311,312,313 and/or may select the multimedia content objects and/or the object containers from the list of available objects to navigate the content hierarchy. Further, the user 15 may employ the hierarchy level tags 311,312,313 and/or may select the multimedia content objects and/or the object containers from the list of available objects to create a set of multimedia content objects. As multimedia content objects are selected, multimedia content may be added to a queue of multimedia content objects. The queue may be an ordered list of multimedia content objects which may be rendered by a selected rendering device.

For example, the system 1 may generate the queue by adding the multimedia content objects selected by the user 15 in the “Full Content Browsing and Selection” step 300. For example, the multimedia content objects selected by the user 15 may be added to the queue in the order which the user 15 selected the multimedia content objects. Depending on the embodiment, a playlist object may be added to the queue as a single object or may be expanded such that all multimedia content objects referenced by the playlist object are added to the queue.

In the “Full Content Browsing and Selection” step 300, the system 1, the user interface 20 and/or the application 25 may provide additional functions and/or additional navigation options. For example, the system 1, the user interface 20 and/or the application 25 may provide a “Play” function 320 that may enable the user 15 to initiate rendering of the selected set of multimedia content objects. If the user 15 selects the “Play” function 320, the system 1 may initiate rendering of the selected set of multimedia content objects by a default rendering device previously specified by the user 15. Alternatively, the system 1, the user interface 20 and/or the application 25 may enable the user 15 to accept and/or to override the default rendering device and/or may enable the user 15 to choose one of the available rendering devices from a list of available rendering devices. The system 1 and/or the user interface 20 may proceed to the “Media Playback and Control” step 400 to provide the rendering status information and/or to enable the user 15 to control rendering of the selected set of multimedia content objects.

The system 1, the user interface 20 and/or the application 25 may provide an “Add Shortcut” function 322 to enable the user 15 to create a new media playback shortcut associated with the set of multimedia content objects selected by the user 15 during the “Full Content Browsing and Selection” step 300. The “Add Shortcut” function 322 may be similar to the “Create Playback Shortcut” step 600 described hereafter.

The system 1, the user interface 20 and/or the application 25 may provide a “Show Queue” function 324 to enable the user 15 to view, to edit, to organize and/or to reorder the selected set of multimedia content objects. The system 1, the user interface 20 and/or the application 25 may display a number of multimedia content objects which may be located in the queue. For example, in FIG. 5, the number of multimedia content objects which are located in the queue is depicted as the number “16” in “Show Queue (16).” After selecting the “Show Queue” function 324, the user 15 may remove one or more of the multimedia content objects from the selected set of multimedia content objects and/or may change an order of the multimedia content objects within the queue.

The “Show Queue” function 324 may provide a “Play” function to enable the user 15 to initiate rendering of selected multimedia content objects and/or to proceed to the “Media Playback and Control” step 400. Further, the “Show Queue” 324 function may provide a “Go To Content Browse” function to enable the user 15 to return to the “Full Content Browsing and Selection” step 300 so that the user 15 may continue to browse the multimedia content objects and/or to add multimedia content objects to the set of selected multimedia content objects.

The system 1, the user interface 20 and/or the application 25 may provide a “Go To Shortcuts” function 330 and/or a “Go To Media Control” function 340 to enable the user 15 to navigate to the “Select and Use Playback Shortcuts” step 200 and/or the “Media Playback and Control” step 400, respectively, without initiating rendering of the set of multimedia content objects selected by the user 15 during the “Full Content Browsing and Selection” step 300. The set of multimedia content objects selected by the user 15 during the “Full Content Browsing and Selection” step 300 may be discarded by the system. For example, the system may discard the set of multimedia content objects selected by the user 15 during the “Browse and Select Content” step after prompting the user 15 to confirm that the set of multimedia content objects may be discarded. Alternatively, the set of selected multimedia content objects may be preserved and/or may be available to the user 15 in a subsequent use of the “Full Content Browsing and Selection” step 300.

Navigation and/or selection of one or more of the multimedia content objects in the “Full Content Browsing and Selection” step 300 may be supplemented and/or may be replaced by other known methods for browsing and/or for selecting multimedia content objects. For example, the system 1, the user interface 20 and/or the application 25 may enable the user 15 to enter search terms and/or filter terms which may be used for a search. The search may retrieve and/or may present a list of multimedia content objects associated with metadata that corresponds to the search terms and/or the filter terms. The system 1, the user interface 20 and/or the application 25 may enable the user 15 to select one or more of the multimedia content objects provided by the search. The system 1, the user interface 20 and/or the application 25 may enable the user 15 to perform a second search using different search terms and/or different filter terms to construct a set of selected multimedia content objects based on one or more searches. The “Full Content Browsing and Selection” step 300 may utilize any method for browsing and/or for selecting multimedia content objects known to one skilled in the art.

FIG. 6 generally illustrates an embodiment of the user interface 20 for the “Media Playback and Control” step 400 in an embodiment of the current invention. FIG. 6 is a functional drawing which shows information and controls which may be presented to and/or may be used by the user 15 of the mobile device at a corresponding step of use of the system. As discussed previously, the drawings do not limit the present invention to a specific layout of information and/or controls. Functional control elements may have various embodiments depending on the capabilities of the mobile device.

As generally illustrated in FIG. 6, the system 1, the user interface 20 and/or the application 25 may display a “Media Playback and Control” screen 401. The system 1, the user interface 20 and/or the application 25 may provide the rendering status information, the playback controls, the rendering device selection controls and/or additional functions and/or navigation options. For example, the rendering status information may have a graphic icon 402 and/or a display of metadata 403 associated with the multimedia content object currently being rendered. The playback controls 410 may be various known rendering control functions such as, for example, play, pause, fast forward, rewind, skip forward to a next content object, skip backward to a previous content object, toggle mute, toggle shuffle mode, toggle repeat mode and/or the like. The playback controls 410 may have additional controls to pause rendering and/or to resume rendering on all of the active rendering devices simultaneously. The invention is not limited to a particular embodiment of the “Media Playback and Control” screen 401, the rendering status information, the playback controls and/or the rendering device selection controls.

The rendering device selection controls 420 may be a list of the available rendering devices, such as, for example, a first graphic representation 421 representative of the first rendering device 21, a second graphic representation 422 representative of the second rendering device 22 and/or a third graphic representation 423 representative of the third rendering device 23. In the specific example depicted in FIG. 6, the second graphic representation 422 representative of the second rendering device 22 indicates that the second rendering device 22 is the currently selected rendering device.

In an embodiment, the rendering devices 21,22,23 may be identified by using a name of the rendering device, a model name of the rendering device, a short description of the rendering device, a graphic depiction of the rendering device and/or the like. Selection of one of the rendering devices 21,22,23 may utilize any known user interface technique for displaying and/or selecting. For example, selection of one of the rendering devices 21,22,23 may be accomplished by a scrolling option to display and/or to select from a list of rendering devices that may be larger than the user interface 20 and/or the mobile device 10 is capable of displaying at one time.

The rendering status information displayed by the system 1, the user interface 20 and/or the application 25 may reflect information about the set of multimedia content objects currently being rendered by the selected rendering device. The playback controls 410 may be customized for and/or may be used to control the rendering by the selected rendering device. The user 15 may use the rendering device selection controls to select a different rendering device. As a result, the rendering status information and/or the playback controls 410 may be updated to correspond to the set of multimedia content objects rendered by the selected rendering device and/or rendering control capabilities of the selected rendering device.

The system 1 and/or the mobile device 10 may have access to only one rendering device. For example, the only rendering device may be the internal rendering device of the mobile device 10. Alternatively, the mobile device 10 may be connected to multiple rendering devices but may determine that only one of the rendering devices is currently available. In these cases, the rendering device selection controls 420 may not be present and/or may be presented in a reduced form which may indicate that rendering device selection is not currently possible.

The rendering status information and/or the metadata 403 associated with the multimedia content object currently being rendered may be displayed as the active metadata tags. For example, the rendering status information for “Title,” “Artist,” “Album,” and/or “Genre” may be displayed as the active metadata tags and/or may be selected by the user 15. Selection of one of the active metadata tags may invoke the “QuickJump Navigation” step 500 and/or may have a result similar to selection of the corresponding active metadata tag from within the “QuickJump Navigation” step 500. The graphic icon 402 associated with the multimedia content object currently being rendered may be displayed as one of the active metadata tags. For example, the graphic icon 402 may represent an album cover for an album corresponding to a music file currently being rendered and/or a television series logo for a television series episode currently being rendered. The user 15 may select the graphic icon 402 to invoke the “QuickJump Navigation” step 500 similar to selection of the active metadata tags for “Album” and/or “TV Series,” respectively.

The system 1, the user interface 20 and/or the application 25 may provide additional functions and/or additional navigation options. For example, the system 1, the user interface 20 and/or the application 25 may provide a “Quick Jump” function 430 to enable the user 15 to invoke the “QuickJump Navigation” step 500. For example, the “Quick Jump” function 430 may be used if the rendering status information in the “Media Playback and Control” step 400 is not displayed as active metadata tags and/or if limited display space prevents all of the active metadata tags from being displayed within the rendering status information. By invoking the “Quick Jump” function 430, the user 15 may enter the “QuickJump Navigation” step 500 described further hereafter.

The system 1, the user interface 20 and/or the application 25 may provide an “Add Shortcut” function 440 to enable the user 15 to create a new media playback shortcut associated with the set of multimedia content objects currently being rendered by the selected rendering device. By selecting the “Add Shortcut” function 440, the user 15 may enter the “Create Playback Shortcut” step 600 described further hereafter.

The system 1, the user interface 20 and/or the application 25 may provide a “Show Queue” function 450 to enable the user 15 to view, to edit, to organize and/or to reorder the selected set of multimedia content objects. The system 1, the user interface 20 and/or the application 25 may display a number of multimedia content objects which may be located in the queue. For example, in FIG. 6, the number of multimedia content objects which are located in the queue is depicted as the number “16” in “Show Queue (16).” After selecting the “Show Queue” function 450, the user 15 may remove one or more of the multimedia content objects from the selected set of multimedia content objects and/or to change an order of the multimedia content objects within the queue.

The “Show Queue” function 450 may provide a “Play” function to enable the user 15 to initiate rendering of selected multimedia content objects and/or to proceed to the “Media Playback and Control” step 400. Further, the “Show Queue” 450 function may provide a “Go To Content Browse” function to enable the user 15 to return to the “Full Content Browsing and Selection” step so that the user 15 may continue to browse the multimedia content objects and/or to add multimedia content objects to the set of selected multimedia content objects.

The system 1, the user interface 20 and/or the application 25 may provide a “Go To Shortcuts” function 460 and/or a “Go To Content Browse” function 470 to enable the user 15 to navigate to the “Select and Use Playback Shortcuts” step 200 and/or the “Full Content Browsing and Selection” step 300, respectively. The “Go To Shortcuts” function 460 and/or the “Go To Content Browse” function 470 may enable the user 15 to select a new set of multimedia content objects and/or to modify the set of multimedia content objects currently being rendered by the selected rendering device. By selecting the “Go To Shortcuts” function 460, the user 15 may replace the set of multimedia content objects currently being rendered by the selected rendering device with a new set of multimedia content objects associated with a selected media playback shortcut. Alternatively, the user 15 may assign the set of multimedia content objects associated with a selected media playback shortcut to a different rendering device without interrupting rendering by the currently selected rendering device. By selecting the “Go To Content Browse” function 470, the user 15 may browse the available multimedia content objects to add one or more of the available multimedia content objects to the set of multimedia content objects currently being rendered by the selected rendering device.

The application 25 may present a “Transfer” function (not shown) by which the user 15 may transfer a set of multimedia content objects from the rendering device currently rendering the set of multimedia content objects to a different rendering device. The user 15 may utilize the “Transfer” function to stop rendering by the rendering device currently rendering the set of multimedia content objects and/or to continue rendering by the different rendering device without interruption of rendering of a current multimedia content object.

The application 25 may present a “Group Renderers” function (not shown) by which the user 15 may form a group of two or more rendering devices to which multimedia content objects may be rendered simultaneously in a synchronized manner. The “Group Renderers” function may utilize the currently selected rendering device by enabling the user 15 to specify additional rendering devices which will join the currently selected rendering device in rendering the currently selected set of multimedia content objects.

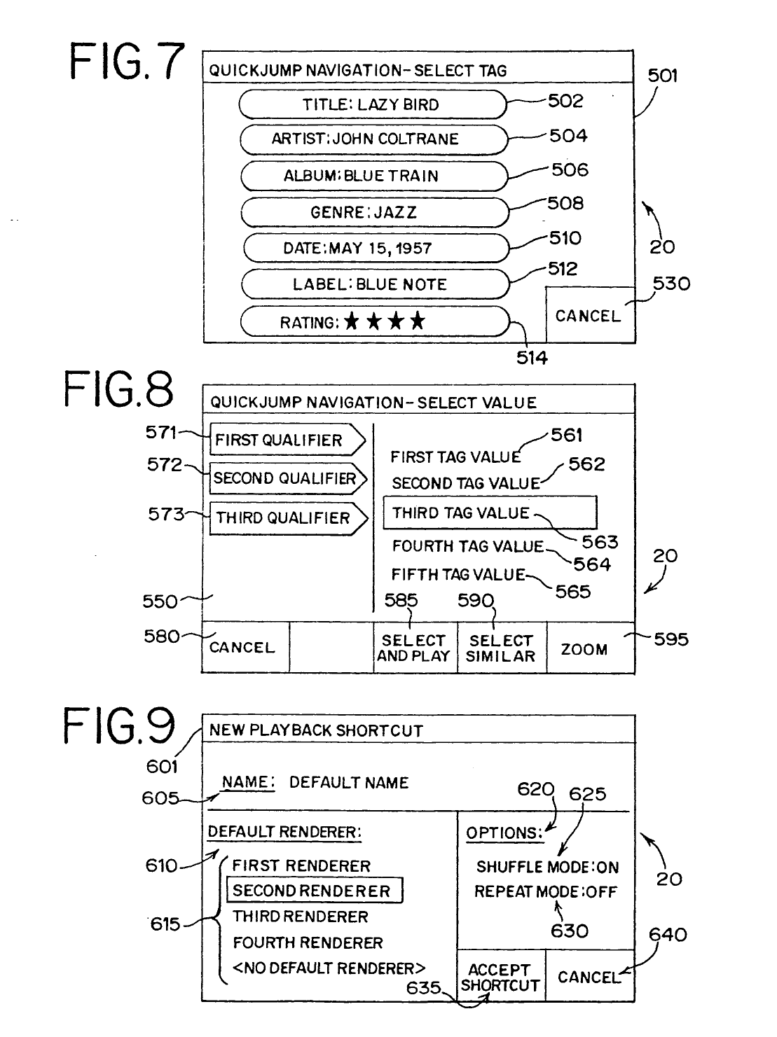

FIGS. 7 and 8 generally illustrate embodiments of the user interface 20 for the “QuickJump Navigation” step 500. As discussed previously, the drawings do not limit the present invention to a specific layout of information and/or controls. Functional control elements may have various embodiments depending on the capabilities of the mobile device.

FIG. 7 generally illustrates an embodiment of the user interface 20 for an initial “Active Metadata Tag Selection” substep of the “QuickJump Navigation” step 500. As generally illustrated in FIG. 7, the system 1, the user interface 20 and/or the application 25 may display an “Active Metadata Tag Selection” screen 501 for the initial “Active Metadata Tag Selection” substep. The initial “Active Metadata Tag Selection” substep may enable the user 15 to select one of the active metadata tags. The subsequent “QuickJump Navigation” step 500 may be based on the active metadata tag selected in the initial “Active Metadata Tag Selection” substep. The initial “Active Metadata Tag Selection” substep may occur when the user 15 selects the “Quick Jump” function 430 during the “Media Playback and Control” step 400. This initial substep may not be necessary for a specific use of the “QuickJump Navigation” step 500. For example, the user 15 may already have selected one of the active metadata tags displayed in the playback status information in the “Media Playback and Control” step 400.

FIG. 7 generally illustrates various active metadata tags which are typical for the Music File content object type. In the specific example depicted in FIG. 7, the initial “Active Metadata Tag Selection” substep displays a “Title” active metadata tag 502, an “Artist” active metadata tag 504, an “Album” active metadata tag 506, a “Genre” active metadata tag 508, a “Recording Date” active metadata tag 510, a “Music Label” active metadata tag 512 and a “Rating” active metadata tag 514. In the specific example depicted in FIG. 7, the associated metadata tag values are “Lazy Bird,” “John Coltrane,” “Blue Train,” “Jazz,” “May 15, 1957,” “Blue Note” and “Four Stars,” respectively. The active metadata tags and/or the metadata tag values displayed may correspond to the multimedia content object which was rendered by the selected rendering device in the “Media Playback and Control” step 400 when the “QuickJump Navigation” step 500 was selected.

The active metadata tags displayed and/or a number of the active metadata tags displayed may vary based on the embodiment of the present invention, a type of multimedia content object currently being rendered, the metadata associated with the multimedia content object currently being rendered and/or the metadata associated with the multimedia content objects available from the content sources. The system 1, the user interface 20 and/or the application 25 may use the “Active Metadata Tag Selection” substep to display more active metadata tags and/or metadata tag values than may be displayed in the “Media Playback and Control” step 400. The invention is not limited to a particular embodiment of the “Active Metadata Tag Selection” screen 501.

The system 1, the user interface 20 and/or the application 25 may provide a “Cancel” function 530 in the “Select Tag” substep to enable the user 15 to return to the “Media Playback and Control” step 400. The “Cancel” function 530 may return the user interface 20 to the “Media Playback and Control” step 400 without changing the set of multimedia content objects currently being rendered.

If the user 15 selects one of the active metadata tags, the system 1, the user interface 20 and/or the application 25 may provide a “Select Value” substep of the “QuickJump Navigation” step 500. For example, the system 1, the user interface 20 and/or the application 25 may provide a “Select Value” screen 550 as generally illustrated in FIG. 8. In the “Select Value” substep, the system 1, the user interface 20 and/or the application 25 may provide a list of metadata tag values; a list of qualifiers; and/or additional functions and/or navigation options. In the specific example depicted in FIG. 8, the system 1, the user interface 20 and/or the application 25 may provide a first tag value 561, a second tag value 562, a third tag value 563, a fourth tag value 564 and/or a fifth tag value 565 in the “Select Value” substep. In the specific example depicted in FIG. 8, the system 1, the user interface 20 and/or the application 25 may provide a first qualifier 571, a second qualifier 572 and/or a third qualifier 573 in the “Select Value” substep. A number of displayed qualifiers and/or a number of displayed tag values may vary as will be apparent from the description hereafter. The invention is not limited to a particular embodiment of the “Select Value” screen 550.

An initially displayed list of metadata tag values and/or an initially displayed list of qualifiers may be based on the active metadata tag which the user 15 selected from the “Media Playback and Control” step 400 and/or from the “Select Tag” substep of the “QuickJump Navigation” step 500. The list of metadata tag values may display available values for the selected active metadata tag. A metadata tag value associated with the selected active metadata tag may be highlighted in the list of metadata tag values and/or may be otherwise graphically distinguished in the list of metadata tag values. The user 15 may select a different metadata tag value before selecting an available function in the “Select Tag” substep of the “QuickJump Navigation” step 500.

The metadata tag values may provide supplementary information. For example, a list of album names may display an associated artist, band, record label, genre, graphic icon and/or the like with each album name in the list of album names. Thus, the metadata tag values may provide the supplementary information to assist the user 15 in selection of one of the album names from the list of album names. The present invention is not limited to a particular embodiment for displaying the supplementary information.

The list of qualifiers may represent a hierarchical organization of available metadata tags. The hierarchical organization of available metadata tags may be similar to the hierarchy level tags 311,312,313 depicted in FIG. 5. The qualifiers may indicate which metadata tag corresponds to the list of metadata tag values, where that metadata tag is located in the hierarchical organization of available metadata tags and/or a scope of the displayed list of metadata tag values. The qualifiers may be displayed as active tags which may be selected by the user 15 to navigate through the metadata tags. The user 15 may select one or more of the qualifiers to navigate to a new list of metadata tag values and/or to change the scope of the displayed list of metadata tag values. The user 15 may select and/or may highlight a metadata tag value from the list of metadata tag values.

The system 1, the user interface 20 and/or the application 25 may provide a “Cancel” function 580 to enable the user 15 to return to the “Media Playback and Control” step 400. The “Cancel” function 580 may enable the user 15 to return to the “Media Playback and Control” step 400 without changing the set of multimedia content objects currently being rendered by the selected rendering device.

The system 1, the user interface 20 and/or the application 25 may present a “Select and Play” function 585 to enable the user 15 to select and/or to render a new set of multimedia content objects which correspond to the currently selected and/or highlighted metadata tag value. The system 1 may initiate rendering of the new set of multimedia content objects to the selected rendering device and may return the user 15 to the “Media Playback and Control” step 400 to enable the user 15 to view the playback status information and/or to control rendering by the selected rendering device.

The system 1, the user interface 20 and/or the application 25 may provide a “Select Similar” function 590 to enable the user 15 to select and/or to render a new set of multimedia content objects which has a metadata tag value similar to the currently selected and/or highlighted metadata tag value. The “Select Similar” function 590 may not be relevant for all metadata tag values. Therefore, a presence of the “Select Similar” function 590 may depend on the currently selected and/or highlighted metadata tag value.

The system 1, the user interface 20 and/or the application 25 may provide a “Zoom” function 595 to enable the user 15 to change the scope of a metadata tag and/or a metadata tag category. For example, the selected metadata tag may be “Genre,” in which case the displayed list of metadata tag values may be a displayed list of Genres, such as, for example, Alternative, Classical, Country, Jazz and/or Rock. If the user 15 selects and/or highlights “Jazz” in the list of metadata tag values, the application may present the “Zoom” function 595 to indicate that the Jazz genre has sub-genres. If the user 15 selects the “Zoom” function 595 with “Jazz” selected and/or highlighted in the list of metadata tag values, the system 1, the user interface 20 and/or the application 25 may present a list of sub-genres for Jazz, such as, for example, “Dixieland,” “Jazz Fusion,” “Latin Jazz” and/or “Smooth Jazz.” The list of sub-genres may replace the list of metadata tag values.

The user 15 may select and/or highlight a sub-genre from the list of sub-genres and/or may select the “Select and Play” function 585 and/or the “Select Similar” function 590 for the selected and/or highlighted sub-genre. Selection of the “Zoom” function 595 may also cause a new qualifier to be added to the displayed list of qualifiers. For example, a “Jazz” qualifier may be added to the list of qualifiers if the user 15 selects the “Zoom” function 595 with “Jazz” highlighted in the list of metadata tag values. The new qualifier may provide a visual indication that the list of displayed metadata tag values has changed. For example, the “Jazz” qualifier may reflect sub-genres of “Jazz” and/or may enable the user 15 to select a qualifier above the “Jazz” qualifier to return to an original Genre view.

In a first example of use of the “QuickJump Navigation” step 500, the user 15 may select the “Quick Jump” function 430 in the “Media Playback and Control” step 400 to proceed to the “Active Metadata Tag Selection” substep of the “QuickJump Navigation” step 500. For example, the user 15 may select the “Quick Jump” function 430 in the “Media Playback and Control” step 400 to view the active metadata tags as generally illustrated in FIG. 7. The user 15 may select the “Title” active metadata tag 502 which corresponds to “Title: Lazy Bird”. The system 1, the user interface 20 and/or the application 25 may proceed to the “Select Value” substep of the “QuickJump Navigation” step 500. As generally illustrated in FIG. 8, the first qualifier 571 may be “All Titles,” the second qualifier 572 may be “Jazz Titles” and/or the third qualifier 573 may be “Blue Train Titles.” The third qualifier 573 may be highlighted in the list of qualifiers and/or may be otherwise graphically distinguished in the list of qualifiers.

The list of metadata tag values may be a list of titles of songs from the “Blue Train” album. For example, “Blue Train” may be the first tag value 561, “Moment's Notice” may be the second tag value 562, “Locomotion” may be the third tag value 563, “I'm Old Fashioned” may be the fourth tag value 564 and/or “Lazy Bird” may be the fifth tag value 565. The fifth tag value 565 “Lazy Bird” may be selected, may be highlighted and/or may be otherwise graphically distinguished in the list of metadata tag values.

The user 15 may select the “Select and Play” function 585 to select and/or to render multimedia content objects which have “Lazy Bird” as the title. Alternatively, the user 15 may select the “Select Similar” function 590 to select and/or to render multimedia content objects which have titles similar to “Lazy Bird.” Alternatively, the user 15 may select and/or highlight a different title from the list of metadata tag values. Then, the user 15 may select the “Select and Play” function 585 to render multimedia content objects which have a title matching the different title. Instead of selecting the “Select and Play” function 585 after selecting and/or highlighting the different title from the list of metadata tag values, the user 15 may select the “Select Similar” function 590 to render multimedia content objects which have titles similar to the selected and/or highlighted title.

The first qualifier 571 “All Titles,” the second qualifier 572 “Jazz Titles” and/or the third qualifier 573 “Blue Train Titles” may indicate that the scope of the titles displayed in the list of metadata tag values may be adjusted to reflect all available titles, only titles of multimedia content objects associated with the “Jazz” genre and/or only titles of multimedia content objects associated with the “Blue Train” album. A qualifier which indicates a current scope of the list of metadata tag values may be highlighted and/or may be otherwise graphically distinguished in the list of qualifiers to indicate the current scope. The user 15 may select one of the displayed qualifiers to adjust the scope of the displayed titles. For example, the user 15 may select the second qualifier 572 “Jazz Titles.” The system 1, the user interface 20 and/or the application 25 may change the displayed list of titles to display a new list of metadata tag values that may be titles of multimedia content objects associated with the “Jazz” genre. The new list of metadata tag values may have titles which may not have been present in the original list of metadata tag values. The user 15 may select and/or may highlight a different title from the new list of metadata tag values. The user may then select the “Select and Play” function 585 to render multimedia content objects with the different title and/or may select the “Select Similar” function 590 to render multimedia content objects which have titles similar to the different title.

In a second example of use of the “QuickJump Navigation” step 500, the user 15 may select the “Quick Jump” function 430 in the “Media Playback and Control” step 400 to proceed to the “Active Metadata Tag Selection” substep of the “QuickJump Navigation” step 500. For example, the user 15 may select the “Quick Jump” function 430 in the “Media Playback and Control” step 400 to view the active metadata tags as generally illustrated in FIG. 7. The user 15 may select the third active metadata tag 506 “Album: Blue Train.” The system 1, the user interface 20 and/or the application 25 may proceed to the “Select Value” substep of the “QuickJump Navigation” step 500. As generally illustrated in FIG. 8, “All Albums” may be the first qualifier 571, “Jazz Albums” may be the second qualifier 572, “John Coltrane Albums” may be the third qualifier 573 and/or “Blue Note Albums” may be a fourth qualifier (not shown). The third qualifier 573 “John Coltrane Albums” may be highlighted in the list of qualifiers. The list of metadata tag values may be a list of available John Coltrane albums. For example, “Blue Train” may be the first tag value 561, “Soultrane” may be the second tag value 562 and/or “Giant Steps” may be the third tag value 563.

The first tag value 561 “Blue Train” may be highlighted and/or may be otherwise graphically distinguished in the list of metadata tag values. The user 15 may select the “Select and Play” function 585 to select and/or to render multimedia content objects associated with the “Blue Train” album. Alternatively, the user 15 may select and/or highlight a different album from the list of metadata tag values, and then the user 15 may select the “Select and Play” function 585 to render multimedia content objects associated with the different album.

The first qualifier 571 “All Albums,” the second qualifier 572 “Jazz Albums,” the third qualifier 573 “John Coltrane Albums” and/or the fourth qualifier “Blue Note Albums” may indicate that the scope of the albums displayed in the list of metadata tag values may be adjusted to reflect all available albums, only albums associated with the “Jazz” genre, only albums associated with artist “John Coltrane” and/or only albums associated with the “Blue Note” label. The user 15 may select one of the displayed qualifiers to adjust the scope of the displayed titles. For example, the user 15 may select the fourth qualifier “Blue Note Albums.” The system 1, the user interface 20 and/or the application 25 may change the displayed list of albums to display a new list of metadata tag values that may be albums associated with the “Blue Note” label. The new list of metadata tag values may have albums which were not present in the original list of metadata tag values. For example, the new list may have “The Sidewinder” and/or “Feels Like Home.” The user 15 may select and/or may highlight a different album from the new list of metadata tag values. The user 15 may then select the “Select and Play” function 585 to render multimedia content objects associated with the different album.

In a third example of use of the “QuickJump Navigation” step 500, the user 15 may select the “Quick Jump” function 430 in the “Media Playback and Control” step 400 to proceed to the “Active Metadata Tag Selection” substep of the “QuickJump Navigation” step 500. For example, the user 15 may select the “Quick Jump” function 430 in the “Media Playback and Control” step 400 to view the active metadata tags as generally illustrated in FIG. 7. The user 15 may select the fourth active metadata tag 508 “Genre: Jazz.” The system 1, the user interface 20 and/or the application 25 may proceed to the “Select Value” substep of the “QuickJump Navigation” step 500. As generally illustrated in FIG. 8, “Music” may be the first qualifier 571, “Local Storage” may be the second qualifier 572 and/or “Genres” may be the third qualifier 573. In this third example of use of the “QuickJump Navigation” step 500, the list of qualifiers may be displayed as a hierarchical list.

The list of metadata tag values may be a list of available genres. For example, “Alternative” may be the first tag value 561, “Classical” may be the second tag value 562, “Country” may be the third tag value 563, “Jazz” may be the fourth tag value 564 and/or “Rock” may be the fifth tag value 565. The fourth tag value 564 “Jazz” may be highlighted and/or may be otherwise graphically distinguished in the list of metadata tag values. The user 15 may select the “Select and Play” function 585 to select and/or to render multimedia content objects associated with the “Jazz” genre. Alternatively, the user 15 may select and/or highlight a different genre from the list of metadata tag values, and then the user 15 may select the “Select and Play” function 585 to render multimedia content objects associated with the different genre.

The system 1, the user interface 20 and/or the application 25 may present the “Zoom” function 595 to obtain sub-genres of the selected and/or highlighted genre. The presence of the “Zoom” function 595 may depend on whether sub-genres are available for the selected and/or highlighted genre. For example, the system 1, the user interface 20 and/or the application 25 may present the “Zoom” function 595 if the “Jazz” genre is selected and/or highlighted in the list of metadata tag values. The user 15 may invoke the “Zoom” function 595. In response, the system 1 may add a fourth qualifier “Jazz” to the list of qualifiers and/or may change the list of metadata tag values to reflect the sub-genres of the “Jazz” genre. For example, “Dixieland” may be the first tag value 561, “Jazz Fusion” may be the second tag value 562, “Latin Jazz” may be the third tag value 563 and/or “Smooth Jazz” may be the fourth tag value 564. The user 15 may select and/or may highlight the second tag value 562 “Jazz Fusion” and then may select the “Select and Play” function 585 to render a set of multimedia content objects associated with the sub-genre of “Jazz Fusion.”

Alternatively, the user 15 may select one of the qualifiers from the list of qualifiers to navigate to a corresponding level of the content hierarchy. For example, the user 15 may select the first qualifier 571 “Music” to view an organization of music files. The system 1, the user interface 20 and/or the application 25 may remove a remainder of the qualifiers so that the first qualifier 571 “Music” is the only displayed qualifier. For example, system 1, the user interface 20 and/or the application 25 may remove the second qualifier 572 “Local Storage” and/or the third qualifier 573 “Genres.” The system 1, the user interface 20 and/or the application 25 may change the list of metadata tag values to reflect options by which music files may be organized and/or may be navigated.

For example, the system 1, the user interface 20 and/or the application 25 may change the list of metadata tag values to “Local Storage” as the first tag value 561, “Home Network” as the second tag value 562 and/or “Music Online” as the third tag value 563. The first tag value 561 “Local Storage,” the second tag value 562 “Home Network,” and/or the third tag value 563 “Music Online” may enable the user 15 to limit the scope of the list of metadata tag values to music files stored locally on the mobile device, music files available in the home network and/or music files accessible via an online music service, respectively.

The user 15 may select the third tag value 563 “Music Online” to access the online music service. As a result, the system 1, the user interface 20 and/or the application 25 may add the second qualifier 572 “Music Online” to the list of qualifiers. Further, the system 1, the user interface 20 and/or the application 25 may change the list of metadata tag values to indicate the metadata tag values by which multimedia content objects from the online music service may be browsed, navigated and/or selected. For example, the first tag value 561 may be changed to “Artist,” the second tag value 562 may be changed to “Genre,” the third tag value 563 may be changed to “Album” and/or the fourth tag value 564 may be changed to “Rating.”

If the user 15 selects the fourth tag value 564 “Rating,” the system 1, the user interface 20 and/or the application 25 may add the third qualifier 573 “Rating” to the list of displayed qualifiers and/or may change the list of metadata tag values to reflect ratings. For example, the ratings may be based on a “five star” rating scale so that the first tag value 561 may be “one star,” the second tag value 562 may be “2 stars,” the third tag value 563 may be “3 stars,” the fourth tag value 564 may be “4 stars,” and/or the fifth tag value 565 may be “5 stars.” The user 15 may select and/or highlight the fourth tag value 564 “4 stars” from the list of metadata tag values. Then, the user 15 may select the “Select and Play” function 585 to select and/or to render a set of multimedia content objects from the online music service which has a rating of four or more stars on the “five star” rating scale.

The system 1, the user interface 20, the application 25 and/or the online music service may limit the set of multimedia content objects to a subset of available multimedia content objects. Limitation of the set of multimedia content objects may be performed randomly, may be based on multimedia content objects currently favored and/or promoted by the online music service, may be based on preferences and/or a content consumption history of the user 15 of the mobile device and/or may be based on some other method.

In a fourth example of use of the “QuickJump Navigation” step 500, the user 15 may select the “Quick Jump” function 430 in the “Media Playback and Control” step 400 to proceed to the “Active Metadata Tag Selection” substep of the “QuickJump Navigation” step 500. For example, the user 15 may select the “Quick Jump” function 430 in the “Media Playback and Control” step 400 to view the active metadata tags as generally illustrated in FIG. 7. The user 15 may select the fifth active metadata tag 510 “Date: May 15, 1957.” The system 1, the user interface 20 and/or the application 25 may proceed to the “Select Value” substep of the “QuickJump Navigation” step 500. As generally illustrated in FIG. 8, “Jazz by Year” may be the first qualifier 571, “Jazz by Decade” may be the second qualifier 572, “Jazz Periods” may be the third qualifier 573 and/or “Other Genres” may be a fourth qualifier (not shown). The first qualifier 571 “Jazz by Year” may be highlighted and/or may be otherwise graphically distinguished in the list of qualifiers.

The list of metadata tag values may be a list of years for which Jazz multimedia content objects are available. For example, the list of metadata tag values may be a list of years between 1923 and a current year. The list of years for which Jazz multimedia content objects are available may be too large for the display capability of the mobile device 10. Thus, the list of years for which Jazz multimedia content objects are available may be displayed as a scrolling list and/or a similar means known to one skilled in the art by which the list may be accessed on the display of the mobile device 10. The year “1957” may be highlighted and/or may be otherwise graphically distinguished in the list of metadata tag values and/or may be located in an initially displayed portion of the scrolling list. The user 15 may select the “Select and Play” function 585 to select and/or to render Jazz multimedia content objects associated with the year “1957.” Alternatively, the user 15 may select and/or highlight a different year from the list of metadata tag values. Then, the user 15 may select the “Select and Play” function 585 to render Jazz multimedia content objects associated with the selected and/or highlighted year.

Alternatively, the user 15 may select the second qualifier 572 “Jazz by Decade.” The system 1, the user interface 20 and/or the application 25 may highlight and/or may otherwise graphically distinguish the second qualifier 572 “Jazz by Decade” in the list of qualifiers. The system 1, the user interface 20 and/or the application 25 may change the list of metadata tag values to reflect decades for which Jazz multimedia content objects are available. For example, “1920's” may be the first tag value 561, “1930's” may be the second tag value 562, “1940's” may be the third tag value 563, “1950's” may be the fourth tag value 563, “1960's” may be the fifth tag value 565, “1970's” may be a sixth tag value (not shown), “1980's” may be a seventh tag value (not shown), “1990's” may be an eighth tag value (not shown) and/or “2000's” may be a ninth tag value (not shown). The fourth tag value 564 “1950's” may be highlighted and/or may be otherwise graphically distinguished in the list of metadata tag values. The user 15 may select the “Select and Play” function 585 to select and/or to render multimedia content objects associated with years from 1950 through 1959 inclusively. Alternatively, the user 15 may select and/or highlight a different decade from the list of metadata tag values, and then the user 15 may select the “Select and Play” function 585 to render multimedia content objects associated with the different decade.

Alternatively, the user 15 may select the third qualifier 573 “Jazz Periods.” The system 1, the user interface 20 and/or the application 25 may highlight and/or may be otherwise graphically distinguish the third qualifier 573 “Jazz Periods” in the list of qualifiers. The system 1, the user interface 20 and/or the application 25 may change the list of metadata tag values to reflect well known time periods and/or associated date ranges for which Jazz multimedia content objects are available. For example, “Early Jazz (1923-1932)” may be the first tag value 561, “Big Band Era (1927-1936)” may be the second tag value 562, “Swing Period (1934-1947)” may be the third tag value 563, “Cool Jazz (1949-1956)” may be the fourth tag value 563, “Free Jazz (1952-1968)” may be the fifth tag value 565, “Fusion (1967-1983)” may be a sixth tag value (not shown) and/or “Post Modern (1978-1992)” may be a seventh tag value (not shown). The fifth tag value 564 “Free Jazz (1952-1968)” may be highlighted and/or may be otherwise graphically distinguished in the list of metadata tag values. The user 15 may select the “Select and Play” function 585 to select and/or to render multimedia content objects associated with years from 1952 through 1968 inclusively. Alternatively, the user 15 may select and/or highlight a different period from the list of metadata tag values, and then the user 15 may select the “Select and Play” function 585 to render multimedia content objects associated with the different period.

Alternatively, the user 15 may select the fourth qualifier “Other Genres” to select music multimedia content objects by date such that selected multimedia content objects are not limited to the “Jazz” genre. If the user 15 selects the fourth qualifier “Other Genres,” the system 1, the user interface 20 and/or the application 25 may enable the user 15 to select an alternative genre, may provide the user 15 with a new list of qualifiers and/or a new list of years, decades and/or periods which may be appropriate to the alternative genre and/or may enable the user 15 to select a set of multimedia content objects associated with the alternative genre as described previously for the Jazz genre. The system 1, the user interface 20 and/or the application 25 may enable the user 15 to remove genre-based limitations so that the user 15 may select music multimedia content objects by date, decade and/or period without the genre-based limitations.

In a fifth example of use of the “QuickJump Navigation” step 500, the user 15 may render a video file of a television show to a video-capable rendering device currently selected in the “Media Playback and Control” step 400. The user 15 may select the “Quick Jump” function 430 in the “Media Playback and Control” step 400 to proceed to the “Active Metadata Tag Selection” substep of the “QuickJump Navigation” step 500. For example, the system 1, the user interface 20 and/or the application 25 may display the following active metadata tags:

Title: Yankee Doodle Doctor

TV Series: M*A*S*H

Genre: Comedy, Drama

Starring: Alan Alda, Wayne Rogers

Date: Oct. 22, 1972

Rating: 4 stars

The user 15 may select the first active metadata tag “Title: Yankee Doodle Doctor” to proceed to the “Metadata Tag Value Selection” substep as generally illustrated in FIG. 8. For example, “All Titles” may be the first qualifier 571, “M*A*S*H Episodes” may be the second qualifier 572 and/or “M*A*S*H Seasons” may be the third qualifier 573. The second qualifier 572 “M*A*S*H Episodes” may be highlighted and/or may be otherwise graphically distinguished in the list of qualifiers. The list of metadata tag values may be a list of titles of available M*A*S*H television show episodes. For example, “Chief Surgeon Who?” may be the first tag value 561, “The Moose” may be the second tag value 562, “Yankee Doodle Doctor” may be the third tag value 563, “Divided We Stand” may be the fourth tag value 564 and/or “The Sniper” may be the fifth tag value 565. The third tag value 563 “Yankee Doodle Doctor” may be highlighted and/or may be otherwise graphically distinguished in the list of metadata tag values.

The user 15 may select the “Select and Play” function 585 to select and/or to render multimedia content objects having a title “Yankee Doodle Doctor” and/or may select the “Select Similar” function 590 to select and/or to render multimedia content objects having a title similar to “Yankee Doodle Doctor.” The user 15 may select and/or may highlight a different title from the list of metadata tag values. The user 15 may select the “Select and Play” function 585 to select and/or to render multimedia content objects which have a title that matches the selected and/or highlighted title and/or may select the “Select Similar” function 590 to select and/or to render a set of multimedia content objects which have a title similar to the selected and/or highlighted title.

Alternatively, the user may select the third qualifier 573 “M*A*S*H seasons” to view a list of available seasons. The system 1, the user interface 20 and/or the application 25 may highlight and/or may otherwise graphically distinguish the third qualifier 573 “M*A*S*H seasons” in the list of qualifiers and/or may change the list of metadata tag values to a list of available seasons. For example, “Season 1” may be the first tag value 561, “Season 2” may be the second tag value 562, “Season 3” may be the third tag value 563 and/or “Season 4” may be the fourth tag value 564. The first tag value 561 “Season 1” may be highlighted and/or may be otherwise graphically distinguished in the list available seasons. The user 15 may select the “Select and Play” function 585 to select and/or to render episodes of M*A*S*H associated with “Season 1.”

The user 15 may select and/or highlight a different season from the list of available seasons and/or may select the “Select and Play” function 585 to select and/or to render episodes of M*A*S*H associated with the different season. The user 15 may select the “Zoom” function 595 to obtain a list of episode titles for episodes of M*A*S*H associated with the selected and/or highlighted season. The system 1, the user interface 200 and/or the application 25 may change the list of metadata tag values and/or may change the list of displayed qualifiers to have a new qualifier which indicates the selected and/or highlighted season. For example, if the user 15 selected the “Zoom” function 595 with the fourth tag value 564 “Season 4” selected and/or highlighted in the list of available seasons, the system 1, the user interface 20 and/or the application 25 may add a fourth qualifier “M*A*S*H Season 4” to the list of qualifiers and/or may highlight and/or may be otherwise graphically distinguish the fourth qualifier “M*A*S*H Season 4” to indicate that the list of metadata tag values has available episode titles for M*A*S*H Season 4.

In a sixth example of use of the “QuickJump Navigation” step 500, the user 15 may render a video file of a television show to a video-capable rendering device currently selected in the “Media Playback and Control” step 400. The user 15 may select the “Quick Jump” function 430 in the “Media Playback and Control” step 400 to proceed to the “Active Metadata Tag Selection” substep of the “QuickJump Navigation” step 500. For example, the system 1, the user interface 20 and/or the application 25 may display the following active metadata tags:

Title: Yankee Doodle Doctor

TV Series: M*A*S*H

Genre: Comedy, Drama

Starring: Alan Alda, Wayne Rogers

Date: Oct. 22, 1972

Rating: 4 stars

The user 15 may select the fourth active metadata tag, “Starring: Alan Alda, Wayne Rogers” to proceed to the “Metadata Tag Value Selection” substep as generally illustrated in FIG. 8. For example, “All Actors” may be the first qualifier 571, “M*A*S*H Actors” may be the second qualifier 572 and/or “Current Episode Actors” may be the third qualifier 573. The third qualifier 573 “Current Episode Actors” may be highlighted and/or may be otherwise graphically distinguished in the list of qualifiers. The list of metadata tag values may be a list of actors who appear in the currently playing M*A*S*H episode, “Yankee Doodle Doctor.” For example, “Alan Alda” may be the first tag value 561, “Larry Linville” may be the second tag value 562, “Wayne Rogers” may be the third tag value 563, “McLean Stevenson” may be the fourth tag value 564 and/or “Loretta Swit” may be the fifth tag value 565. The first tag value 561 “Alan Alda” may be highlighted and/or may be otherwise graphically distinguished in the list of metadata tag values.

The user 15 may select the “Select and Play” function 585 to select and/or to render a set of multimedia content objects associated with the actor “Alan Alda.” Alternatively, the user 15 may select and/or may highlight a different actor from the list of metadata tag values. The user 15 may select the “Select and Play” function 585 to select and/or to render a set of multimedia content objects associated with the different actor.

The user 15 may select the second qualifier 572 “M*A*S*H Actors” to obtain a list of actors associated with the M*A*S*H television show. The system 1, the user interface 20 and/or the application 25 may highlight and/or may otherwise graphically distinguish the second qualifier 572 “M*A*S*H Actors” in the list of qualifiers and/or may change the list of metadata tag values to display a list of actors associated with “M*A*S*H.” The list of actors associated with “M*A*S*H” may have actors who appeared in “Yankee Doodle Doctor” and were included in the original list of metadata tag values and/or may have additional actors who did not appear in “Yankee Doodle Doctor.” For example, the list of actors associated with “M*A*S*H” may have “Mike Farrell,” “Harry Morgan,” and/or “David Odgen Stiers” in addition to the actors included in the original list. The first tag value 561 “Alan Alda” which was highlighted in the original list of actors may remain highlighted in the list of actors associated with “M*A*S*H.” The user 15 may select and/or may highlight a different actor from the list of actors associated with “M*A*S*H.” The user 15 may select the “Select and Play” function 585 to select and/or to render a set of multimedia content objects associated with the different actor.

In a seventh example of use of the “QuickJump Navigation” step 500, the user 15 may render a set of digital photographs on a selected rendering device. The user 15 may be viewing the playback status information and/or may be controlling rendering on the selected rendering device using the “Media Playback and Control” step 400. The user 15 may select the “Quick Jump” function 430 in the “Media Playback and Control” step 400 to proceed to the “Active Metadata Tag Selection” substep of the “QuickJump Navigation” step 500. The system 1, the user interface 20 and/or the application 25 may display active metadata tags associated with the digital photograph currently displayed on the selected rendering device. For example, the system 1, the user interface 20 and/or the application 25 may display the following active metadata tags:

Filename: img0796.jpg

Keywords: vacation, hiking, Nathan

Date: Aug. 24, 2003

Location: Mt. Tamalpais State Park

Album: Trip to California

The user 15 may select the second active metadata tag, “Keywords: vacation, hiking, Nathan” to proceed to the “Metadata Tag Value Selection” substep as generally illustrated in FIG. 8. The list of qualifiers may have “All Keywords” as the first qualifier 571, “Keywords in Album” as the second qualifier 572 and/or “Keywords in Photo” as the third qualifier 573. The third qualifier 573 “Keywords in Photo” may be highlighted and/or may be otherwise graphically distinguished in the list of qualifiers. The list of metadata tag values may be a list of keywords associated with the digital photograph currently displayed. For example, “vacation” may be the first tag value 561, “hiking” may be the second tag value 562 and/or “Nathan” may be the third tag value 563. One of the keywords may be highlighted and/or may be otherwise graphically distinguished in the list of keywords.

The user 15 may select the “Select and Play” function 585 to select and/or to render a set of multimedia content objects associated with the highlighted keyword. Alternatively, the user 15 may select and/or may highlight a different keyword in the list of keywords. Then the user 15 may invoke the “Select and Play” function 585 to select and/or to render a set of multimedia content objects associated with the different keyword.

The user 15 may select the second qualifier 572 “Keywords in Album” to obtain a list of keywords associated with photos in the “Trip to California” album, and/or the user 15 may select the first qualifier 571 “All Keywords” to obtain a list of all available keywords. In either case, the user 15 may select and/or highlight a keyword in the new list of keywords. The user 15 may select the “Select and Play” function 585 to select and/or to render a set of multimedia content objects associated with the selected and/or highlighted keyword.

In an eighth example of use of the “QuickJump Navigation” step 500, the user 15 may render a set of digital photographs on a selected rendering device. The user 15 may select the “Quick Jump” function 430 in the “Media Playback and Control” step 400 to proceed to the “Active Metadata Tag Selection” substep of the “QuickJump Navigation” step 500. The system 1, the user interface 20 and/or the application 25 may display active metadata tags associated with the digital photograph currently displayed on the selected rendering device. For example, the system 1, the user interface 20 and/or the application 25 may display the following active metadata tags:

Filename: img0796.jpg

Keywords: vacation, hiking, Nathan

Date: Aug. 24, 2003

Location: Mt. Tamalpais State Park

Album: Trip to California

The user 15 may select the fourth active metadata tag, “Location: Mt. Tamalpais State Park” to proceed to the “Metadata Tag Value Selection” substep as generally illustrated in FIG. 8. For example, the list of qualifiers may have “All Locations” as the first qualifier 571, “USA” as the second qualifier 572, “California” as the third qualifier 573 and/or “San Francisco Area” as a fourth qualifier (not shown). The fourth qualifier “San Francisco Area” may be highlighted and/or may be otherwise graphically distinguished in the list of qualifiers. The list of metadata tag values may be a list of locations in the San Francisco Area for which associated photos may be available. For example, “Golden Gate Park” may be the first tag value 561, “Mount Tamalpais” may be the second tag value 562, “Pier 39” may be the third tag value 563, “Point Reyes” may be the fourth tag value 564 and/or “SF Chinatown” may be the fifth tag value 565. The second tag value 562 “Mount Tamalpais” may be highlighted and/or may be otherwise graphically distinguished in the list of locations.

The user 15 may select the “Select and Play” function 585 to select and/or to render a set of multimedia content objects associated with “Mount Tamalpais.” Alternatively, the user 15 may select and/or highlight a different location from the list of locations. Then the user 15 may select the “Select and Play” function 585 to select and/or to render a set of multimedia content objects associated with the different location.

The user 15 may select one of the qualifiers from the list of qualifiers to change the scope of the list of metadata tag values. For example, the user 15 may select the third qualifier 573 “California.” The system 1, the user interface 20 and/or the application 25 may highlight and/or may otherwise graphically distinguish the third qualifier 573 in the list of qualifiers and/or may change the list of metadata tag values to a new list of metadata tag values to reflect locations in California for which associated photos are available. The new list of metadata tag values may have locations associated with “San Francisco Area” which were displayed in the original list of locations and/or may have locations which were not located in the original list of locations. For example, the new list of metadata tag values may have “Yosemite National Park,” “Lake Redding,” and “Disneyland.” The user 15 may select and/or may highlight a location from the new list of metadata tag values. Then the user 15 may select the “Select and Play” function 585 to select and/or to render a set of multimedia content objects associated with the selected and/or highlighted location.

The metadata tags, the metadata tag values and the qualifiers listed the preceding examples are intended to illustrate the functionality and advantages of the “QuickJump Navigation” step 500. Specific metadata tags, specific tag values and specific qualifiers may vary based on the embodiment of the present invention, the available content sources, the multimedia content objects and/or the metadata associated with the multimedia content objects. The present invention is not limited to a specific embodiment of the metadata tags, the metadata tag values and the qualifiers.

FIG. 9 generally illustrates an embodiment of the user interface 20 for the “Create Playback Shortcut” step 600. As discussed previously, the drawings do not limit the present invention to a specific layout of information and/or controls. Functional control elements may have various embodiments depending on the capabilities of the mobile device.

The “Create Playback Shortcut” step 600 may be invoked when the system 1, the user interface 20 and/or the application 25 may have a currently selected set of multimedia content objects and/or a currently selected rendering device. For example, the system 1 may render the selected set of multimedia content objects to the selected rendering device using the “Media Playback and Control” step 400. Alternatively, the user 15 may select multimedia content objects using the “Full Content Browsing and Selection” step 300 during which a default rendering device may be defined.

Selection of the “Create Playback Shortcut” step 600 may only require a set of selected multimedia content objects. The set of selected multimedia content objects and/or the selected rendering device, if any, may have been selected by any available means.

The “Create Playback Shortcut” step 600 may enable the user 15 to create a new media playback shortcut which may be available on subsequent selections of the “Select and Use Playback Shortcuts” step 200. The new media playback shortcut may be associated with the currently selected set of multimedia content objects. The user 15 may associate a default rendering device and/or other default playback settings with the new media playback shortcut.

The system 1, the user interface 20 and/or the application may provide a “Create Playback Shortcut” screen 601 as generally illustrated in FIG. 9. The system 1, the user interface 20 and/or the application 25 may provide a naming control 605 for naming the new playback shortcut. The naming control 605 may have a default name for the new playback shortcut.

The default name may describe the currently selected set of multimedia content objects and/or a method by which the user 15 selected the currently selected set of multimedia content objects. The default name may have and/or may be related to a metadata tag value by which the user 15 selected the currently selected set of multimedia content objects using the “QuickJump Navigation” step 500. For example, if the user 15 used the “QuickJump Navigation” step 500 to select a set of video multimedia content objects associated with the television series “M*A*S*H,” the default name may be and/or may be related to “M*A*S*H.” As a further example, if the user 15 used the “QuickJump Navigation” step 500 to select a set of music multimedia content objects based on the Post Modern Jazz period, the default name may be and/or may be related to “Post Modern Jazz.”

The user 15 may accept the default name. Thus, the user 15 may avoid entering a name for the new media playback shortcut. Alternatively, the user 15 may not accept the default name, may edit the default name and/or may provide a new name for the new playback shortcut using a text input method appropriate for the specific mobile device 10.

The system 1, the user interface 20 and/or the application 25 may provide a rendering device selection control 610 for selecting and/or for specifying the default rendering device associated with the new media playback shortcut. The rendering device selection control 610 may have a list of available rendering devices 615. If one of the rendering devices was selected in a step prior to the “Create Playback Shortcut” step 600, then the rendering device may be initially selected, may be initially highlighted and/or may be otherwise graphically distinguished in the list of available rendering devices. For example, if the “Create Playback Shortcut” step 600 was invoked from the “Media Playback and Control” step 400, then the selected rendering device from the “Media Playback and Control” step 400 may be initially selected, may be initially highlighted and/or may be otherwise graphically distinguished in the list of available rendering devices.

The user 15 may accept the default rendering device. Thus, the user 15 may avoid selecting and/or specifying the default rendering device associated with the new media playback shortcut. Alternatively, the user 15 may select and/or may specify a different rendering device associated with the new media playback shortcut and/or may specify that no default rendering device is associated with the new media playback shortcut.

The system 1, the user interface 20 and/or the application 25 may provide options 620 to specify other default playback settings associated with the new playback shortcut. For example, the system 1, the user interface 20 and/or the application 25 may provide a Shuffle Mode selector 625 to enable the user 15 to establish a default Shuffle Mode. For example, the system 1, the user interface 20 and/or the application 25 may provide a Repeat Mode selector 630 to enable the user 15 to establish a default Repeat Mode.

The system 1, the user interface 20 and/or the application 25 may provide additional default playback settings options which may be appropriate for the currently selected set of multimedia content objects. For example, if the currently selected set of multimedia content objects has digital photographs, the system 1, the user interface 20 and/or the application 25 may provide an option to set a default time spacing for displaying photographs in a slide show mode. In a preferred embodiment, the additional default playback settings options may be related to and/or may be determined by rendering capabilities of the available rendering devices. The invention is not limited to a specific embodiment of the additional default playback settings options.

The user 15 may accept default playback settings which may be initially displayed by the system 1, the user interface 20 and/or the application 25. Thus, the user 15 may avoid modifying the default playback settings. Alternatively, the user 15 may choose to modify the default playback settings.

The system 1, the user interface 20 and/or the application 25 may provide an “Accept Shortcut” function 635 to enable the user 15 to accept currently displayed settings and/or to create the new media playback shortcut. The user 15 may select the “Accept Shortcut” function 635 immediately upon reaching the “Create Playback Shortcut” step 600 to accept the displayed defaults and to create the new media playback shortcut without providing, selecting and/or modifying the displayed settings. Alternatively, the user 15 may modify the displayed settings according to needs and/or preferences. Then the user 15 may select the “Accept Shortcut” function 635. The system 1, the user interface 20 and/or the application 25 may provide a “Cancel” function 640 to enable the user 15 to abort the “Create Playback Shortcut” step 600 without creating a new shortcut.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for a user to control media rendering using a mobile device, rendering devices and content sources wherein media content objects are available from one or more content sources, the method comprising the steps of:
displaying graphic representations on the mobile device wherein each of the graphic representations is associated with a set of the media content objects and further wherein at least one of the graphic representations is associated with a target rendering device of the rendering devices;
selecting a first graphic representation of the graphic representations with user input on the mobile device; and
rendering the set of the media content objects associated with the first graphic representation on the target rendering device associated with the first graphic representation without user input selecting the target rendering device subsequent to selection of the first graphic representation.

2. The method of claim 1 further comprising the steps of:
establishing a rendering session based on user input on the mobile device which identifies a plurality of the media content objects to be rendered on a first rendering device of the rendering devices in the rendering session;
rendering at least one of the plurality of the media content objects on the first rendering device; and
creating the first graphic representation based on the rendering session wherein creation of the first graphic representation based on the rendering session associates the first graphic representation with the first rendering device and further wherein creation of the first graphic representation based on the rendering session establishes the plurality of the media content objects as the set of the media content objects associated with the first graphic representation wherein the first graphic representation is created before selection of the first graphic representation.

3. The method of claim 1 further comprising the steps of:
recording a log based on the media content objects rendered by the user over a time period wherein the log records metadata associated with the media content objects rendered by the user over the time period; and
creating the first graphic representation based on the log wherein the set of the media content objects associated with the first graphic representation are based on analysis of the metadata recorded in the log.

4. The method of claim 1 further comprising the step of:
associating the first graphic representation with a metadata tag value wherein the set of the media content objects associated with the first graphic representation is determined in response to selection of the first graphic representation by the user and further wherein the set of the media content objects associated with the first graphic representation is determined by matching the metadata tag value to the media content objects available from at least one of the one or more content sources.

5. The method of claim 1 further comprising the step of:
associating the first graphic representation with a rendering setting before selection of the first graphic representation by the user wherein rendering of the set of the media content objects associated with the first graphic representation is based on the rendering setting.

6. The method of claim 1 further comprising the steps of:
presenting controls on the mobile device for selecting an alternate rendering device of the rendering devices based on user input on the mobile device;
selecting a second graphic representation of the graphic representations with user input on the mobile device; and
rendering the set of the media content objects associated with the second graphic representation wherein the set of the media content objects associated with the second graphic representation are rendered on the alternate rendering device if the alternate rendering device was selected using the controls before selection of the second graphic representation and further wherein the set of the media content objects associated with the second graphic representation are rendered on the target rendering device associated with the second graphic representation if the alternate rendering device was not selected using the controls before the selection of the second graphic representation.

7. A method for using a mobile device having a user interface to identify a set of media content objects from media content objects available from one or more content sources wherein the set of media content objects is based on a first media content object having characteristics, the method comprising the steps of:
displaying metadata tags associated with the first media content object wherein the mobile device displays the metadata tags and further wherein each of the metadata tags is associated with metadata tag values which represent characteristics of the media content objects available from the one or more content sources;
identifying a selected metadata tag of the metadata tags associated with the first media content object wherein the selected metadata tag is identified based on user input on the mobile device;
displaying metadata tag values associated with the selected metadata tag wherein the mobile device displays the metadata tag values and further wherein at least one of the metadata tag values which are displayed is at least one of the characteristics of the first media content object;
identifying a selected metadata tag value of the metadata tag values wherein the selected metadata tag value is identified based on user input on the mobile device; and
identifying the set of media content objects from the media content objects available from the one or more content sources wherein the set of media content objects is identified based on the selected metadata tag value.

8. The method of claim 7 further comprising the step of:
rendering the first media content object wherein rendering of the first media content object is controlled by user input on the mobile device and further wherein the rendering of the first media content object begins before the selected metadata tag is identified.

9. The method of claim 7 further comprising the steps of:
rendering a previous set of media content objects in sequence on a rendering device wherein the first media content object is included in the previous set of media content objects and further wherein the rendering device begins rendering the first media content object before selection of the selected metadata tag;
stopping rendering of the previous set of media content objects on the rendering device; and
rendering the set of media content objects identified based on the selected metadata tag value.

10. The method of claim 7 further comprising the step of:
displaying the metadata tags on the mobile device concurrently with rendering controls which control rendering of the first media content object on a rendering device.

11. The method of claim 7 further comprising the step of:
presenting a control in the user interface of the mobile device wherein the metadata tags are displayed in response to the user invoking the control.

12. The method of claim 7 further comprising the step of:
displaying the metadata tag values which are the characteristics of the first media content object on the mobile device wherein the metadata tag values which are the characteristics of the first media content object are displayed concurrently with the metadata tags associated with the first media content object.

13. The method of claim 7 further comprising the step of:
displaying a highlighted metadata tag value in the metadata tag values displayed by the mobile device wherein the highlighted metadata tag value is one of the characteristics of the first media content object.

14. The method of claim 7 further comprising the step of:
storing a reference to the set of media content objects wherein the reference is created based on user input on the mobile device and further wherein selection of the reference after the reference is stored enables the user to access the set of media content objects.

15. The method of claim 7 further comprising the steps of:
creating a playback shortcut associated with a rendering device and the selected metadata tag value;
displaying the playback shortcut on the mobile device;
selecting the playback shortcut wherein a user selects the playback shortcut based on user input on the mobile device; and
rendering the set of media content objects in sequence on the rendering device wherein the set of media content objects is determined based on the selected metadata tag value after selection of the playback shortcut by the user.

16. The method of claim 7 further comprising the step of:
presenting scoping controls on the mobile device concurrently with display of the metadata tag values on the mobile device wherein the scoping controls enable a user to modify a scope of the metadata tag values to one of a narrower scope of the metadata tag values and a broader scope of the metadata tag values.

17. The method of claim 7 further comprising the step of:
searching one or more content sources accessible to the mobile device for media content objects having metadata which corresponds to the selected metadata tag value wherein the set of media content objects is determined by searching the one or more content sources.

18. The method of claim 7 wherein at least one of the metadata tags displayed by the mobile device is represented as a graphic icon which visually indicates one or more of the characteristics of the first media content object.

19. A system for a user to control rendering of media content objects by rendering devices wherein the media content objects are available from content sources, the system comprising:
a mobile device having a user interface; and
an application executed by the mobile device wherein the application directs the mobile device to display playback shortcuts and further wherein each of the playback shortcuts is associated with a set of the media content objects wherein at least one of the playback shortcuts is associated with a target rendering device of the rendering devices and further wherein the application directs the target rendering device associated with a selected playback shortcut of the playback shortcuts to render the set of the media content objects associated with the selected playback shortcut in response to user input on the mobile device identifying the selected playback shortcut.

20. The system of claim 19 wherein a rendering session identifies a plurality of the media content objects to be rendered on one of the rendering devices based on user input on the mobile device and further wherein the one of the rendering devices renders at least one of the plurality of the media content objects wherein the application creates a first playback shortcut of the playback shortcuts based on the rendering session and further wherein the target rendering device associated with the first playback shortcut is the one of the rendering devices used in the rendering session wherein the set of the media content objects associated with the first playback shortcut is the plurality of the media content objects used in the rendering session.

21. The system of claim 19 wherein the application associates a first playback shortcut of the playback shortcuts with one or more metadata parameters and further wherein the application determines the set of the media content objects associated with the first media playback shortcut based on the one or more metadata parameters after the mobile device receives the user input identifying the selected playback shortcut.

22. The system of claim 19 wherein the application associates a first playback shortcut of the playback shortcuts with a rendering setting based on user input on the mobile device and further wherein rendering of the set of the media content objects associated with the first playback shortcut is based on the rendering setting.
